(19) United States
(12) Patent Application Publication
(10) Pub. No.: US 2024/0367903 A1
(43) Pub. Date: Nov. 7, 2024

(54) ARTICLE CONVEYING SYSTEM

(71) Applicant: JAPAN CASH MACHINE CO., LTD., Osaka (JP)

(72) Inventors: Takashi UEDA, Osaka (JP); Yoshiaki UEMIZO, Osaka (JP); Tomonori KITANO, Osaka (JP); Shin IOSE, Osaka (JP); Kazuyoshi NAKATANI, Osaka (JP); Yoshimi EZAWA, Osaka (JP)

(21) Appl. No.: 18/572,111

(22) PCT Filed: Feb. 9, 2022
(86) PCT No.: PCT/JP2022/005173

§ 371 Date: Dec. 19, 2023

(30) Foreign Application Priority Data
Jun. 30, 2021 (JP) 2021-108380

(51) Int. Cl. B65G 1/137; B25J 9/16; B65G 1/04

(52) U.S. Cl. CPC B65G 1/1373; B25J 9/1694; B65G 1/04

(57) ABSTRACT

It is the purpose of the present invention to provide an article conveying system that can efficiently proceed conveying work even when the number of articles placed at each shelf position is different in a situation where a plurality of the articles is placed side by side along the depth direction of a shelf. An article conveying system 100 according to the present invention comprises a conveying device 400, a distance measuring device 690, and a management unit 900. The conveying device is capable of conveying an article BL, BS. The distance measuring device measures a distance from a predetermined position to an object in a predetermined direction. The management unit manages presence or absence of the article based on information about the distance to the object measured by the distance measuring device located at the predetermined position.

### TECHNICAL FIELD

The present invention relates to an article conveying system.

### BACKGROUND ART

The present invention relates to a technique for controlling an article conveyance apparatus that takes out article(s) from a shelf or the like and/or places article(s) on the shelf or the like. In the past, “an automatic warehouse comprising a large number of shelves for storing an article and an article conveying device (for example, a stacker crane) for conveying articles to the shelves” has been proposed (see, for example, Unexamined Japanese Patent Publication No. 2003-026306). In this automatic warehouse, when an article is conveyed, an elevating table (conveying body) of a stacker crane is stopped in front of a target shelf, and a conveying device on the elevating table starts an operation of receiving or conveying the article.

### PRIOR ART DOCUMENT

### Patent Document

PATENT DOCUMENT 1: Unexamined Japanese Patent Publication No. 2003-026306

### SUMMARY OF THE INVENTION

### Problem to be Solved by the Invention

Incidentally, a situation in which a plurality of articles is placed side by side along the depth direction of the shelf can be anticipated. In such a situation, if the number of articles placed at each shelf position is different and the article conveying device is subjected to repetitive operation control, an idle operation of the article conveying device increases, and the work efficiency of the article conveying device decreases.

It is the purpose of the present invention to provide an article conveying system that can efficiently proceed conveying work even when the number of articles placed at each shelf position is different in a situation where a plurality of the articles is placed side by side along the depth direction of a shelf.

### Means for Solving the Problem

An article conveying system according to a first aspect of the present invention comprises a conveying device, a distance measuring device, and a management unit. The conveying device is capable of conveying an article. The distance measuring device measures a distance from a predetermined position to an object in a predetermined direction. The management unit manages presence or absence of the article based on information about the distance to the object measured by the distance measuring device located at the predetermined position. Incidentally, the terms “article” and “object” are used in the description of the present invention, “article” shows an object to be conveyed, and “object” shows any object (for example, a wall, a door, or the like) including an object to be conveyed.

As described above, in this article conveying system, the management unit manages the presence or absence of the article based on the information about the distance to the object measured by the distance measuring device located at the predetermined position. For this reason, in this article conveying system, it is possible to prevent the conveying device from performing a wasteful idle operation or the like. Therefore, in this article conveying system, it is possible to efficiently proceed work of conveying the article.

The article conveying system according to a second aspect of the present invention is the article conveying system according to the first aspect, and the conveying device is a grasping device. The grasping device is capable of grasping the article. The distance measuring device is attached to the conveying device.

As mentioned above, in this article conveying system, the distance measuring device is attached to the conveying device. For this reason, in this article conveying system, the distance measuring device can also move as the grasping device moves. Therefore, in this article conveying system, it is not necessary to install the distance measuring device at each shelf position or the like, and thus it is possible to reduce the construction cost of the article conveying system.

The article conveying system according to a third aspect of the present invention is the article conveying system according to the first aspect or the second aspect, and the management unit includes a storage unit. When the distance exceeds a threshold value, the management unit causes the storage unit to store information showing that there is no article.

As described above, in this article conveying system, when the distance exceeds the threshold value, the management unit causes the storage unit to store information showing that there is no article. For this reason, in this article conveying system, it is possible to accurately determine the presence or absence of the article.

The article conveying system according to a fourth aspect of the present invention is the article conveying system according to the third aspect, and the article conveying system is an article conveying-out system for conveying out the article placed on a shelf including at least one of at least one column and at least one stage. Then, this article conveying system further comprises a control unit. Incidentally, the control unit may constitute the same device as the management unit. When information showing that there is no article is associated with information showing a first shelf position of the shelf and is stored in the storage unit in the management unit, the control unit moves the conveying device to the predetermined position corresponding to a second shelf position. Incidentally, here, the second shelf position is different from the first shelf position.

As described above, in this article conveying system, when information showing that there is no article is associated with information showing the first shelf position of the shelf in the management unit and is stored in the storage unit, the control unit moves the conveying device to the predetermined position corresponding to the second shelf position. For this reason, in this article conveying system, it is possible to efficiently proceed work of conveying out the article from the shelf.

The article conveying system according to a fifth aspect of the present invention is the article conveying system according to the third aspect, and the article conveying system is an article conveying-in system for conveying in the article to a shelf having at least one of at least one column and at least one stage. In addition, the storage unit stores information about dimensions of the article. Then, this article conveying system further comprises a control unit. Incidentally, the control unit may constitute the same device as the management unit. When numerical value information based on the dimensions of the article is associated with information showing a first shelf position of the shelf and is stored in the storage unit in the management unit, and the numerical value information stored in the storage unit satisfies a specific condition, the control unit moves the conveying device to the predetermined position corresponding to a second shelf position. Incidentally, here, the second shelf position is different from the first shelf position.

As described above, in this article conveying system, when the information about dimensions shorter than the dimensions of the article is associated with the information showing the first shelf position of the shelf in the management unit and is stored in the storage unit, the control unit moves the conveying device to the predetermined position corresponding to the second shelf position. For this reason, in this article conveying system, it is possible to efficiently proceed work of conveying in the article to the shelf.

### BRIEF DESCRIPTION OF THE DRAWINGS

FIG. 1 It is a schematic diagram showing an overall configuration of a conveying processing system according to an embodiment of the present invention.

FIG. 2 It is a schematic block diagram showing a control system of the conveying processing system according to an embodiment of the present invention.

FIG. 3 It is an external perspective view of an example of a bill storage container to be conveyed and unlocked by the conveying processing system according to an embodiment of the present invention when viewed from the right obliquely above the front side.

FIG. 4 It is an external perspective view of an example of the bill storage container to be conveyed and unlocked by the conveying processing system according to an embodiment of the present invention when viewed from the left obliquely below the back side.

FIG. 5 It is an external perspective view of another example of the bill storage container to be conveyed and unlocked by the conveying processing system according to an embodiment of the present invention when viewed from the right obliquely above the front side.

FIG. 6 It is an external perspective view of another example of the bill storage container to be conveyed and unlocked by the conveying processing system according to an embodiment of the present invention when viewed from the left obliquely below the back side.

FIG. 7 It is a perspective view of a first conveying-in conveyor and a conveying-in side posture changing device that constitute the conveying processing system according to an embodiment of the present invention when viewed from the right obliquely above the conveying-in side posture changing device side.

FIG. 8 It is a back view of the conveying-in side posture changing device that constitutes the conveying processing system according to an embodiment of the present invention.

FIG. 9 It is a perspective view of an article support device that constitutes the conveying-in side posture changing device of the conveying processing system according to an embodiment of the present invention.

FIG. 10 It is a perspective view of an article grasping rotation device that constitutes the conveying-in side posture changing device of the conveying processing system according to an embodiment of the present invention.

FIG. 11 It is a back view of the conveying-in side posture changing device that constitutes the conveying processing system according to an embodiment of the present invention, and is a view showing a state that a slider of the article grasping rotation device moves forward and a grasping portion is grasping the bill storage container.

FIG. 12 It is a perspective view of a conveying-out side posture changing device and a second conveying-out conveyor that constitutes the conveying processing system according to an embodiment of the present invention when viewed from the right obliquely above the second conveying-out conveyor side.

FIG. 13 It is a perspective view of an article support device that constitutes the conveying-out side posture changing device of the conveying processing system according to an embodiment of the present invention.

FIG. 14 It is a plan view of a robot arm with a robot hand according to an embodiment of the present invention.

FIG. 15 It is a perspective view of the robot hand according to an embodiment of the present invention when viewed from the left obliquely above the front side.

FIG. 16 It is a perspective view of the robot hand according to an embodiment of the present invention when viewed from the right obliquely above the rear side.

FIG. 17 It is a perspective view of the robot hand according to an embodiment of the present invention when viewed from the right obliquely below the front side.

FIG. 18 It is a left side view of the robot hand according to an embodiment of the present invention.

FIG. 19 It is a front view of the robot hand according to an embodiment of the present invention.

FIG. 20 It is I-I cross-sectional view of FIG. 19.

FIG. 21 It is II-II cross-sectional view of FIG. 19.

FIG. 22 It is a left side view of a state in which an articulated telescopic link mechanism is extended in the robot hand according to an embodiment of the present invention.

FIG. 23 It is a left side view of a state in which the articulated telescopic link mechanism is fully extended in the robot hand according to an embodiment of the present invention.

FIG. 24 It is a perspective view of a detachable spiral spring unit of the robot hand according to an embodiment of the present invention.

FIG. 25 It is a front view of a movable shelf on which the bill storage container to be conveyed by the robot arm with the robot hand according to an embodiment of the present invention is placed.

FIG. 26 It is a side view of the movable shelf on which the article to be conveyed by the robot arm with the robot hand according to an embodiment of the present invention is placed.

FIG. 27 It is an image diagram showing a dimension data table according to an embodiment of the present invention.

FIG. 28 It is an image figure showing a shelf data table according to an embodiment of the present invention. Incidentally, in this figure, an initial state before a process of conveying out the bill storage container placed on the movable shelf is performed is shown.

FIG. 29 It is an image figure showing the shelf data table according to an embodiment of the present invention. Incidentally, in this figure, a state in which the bill storage container is conveyed out from the movable shelf and the bill storage container is not placed at a part of a shelf position of the movable shelf is shown.

FIG. 30 It is an image figure showing the shelf data table according to an embodiment of the present invention. Incidentally, in this figure, a state in which a process of conveying in the bill storage container to a part of the shelf position of the movable shelf is performed is shown.

### MODE FOR CARRYING OUT THE INVENTION

### <Configuration of a Conveying Processing System According to an Embodiment of the Present Invention>

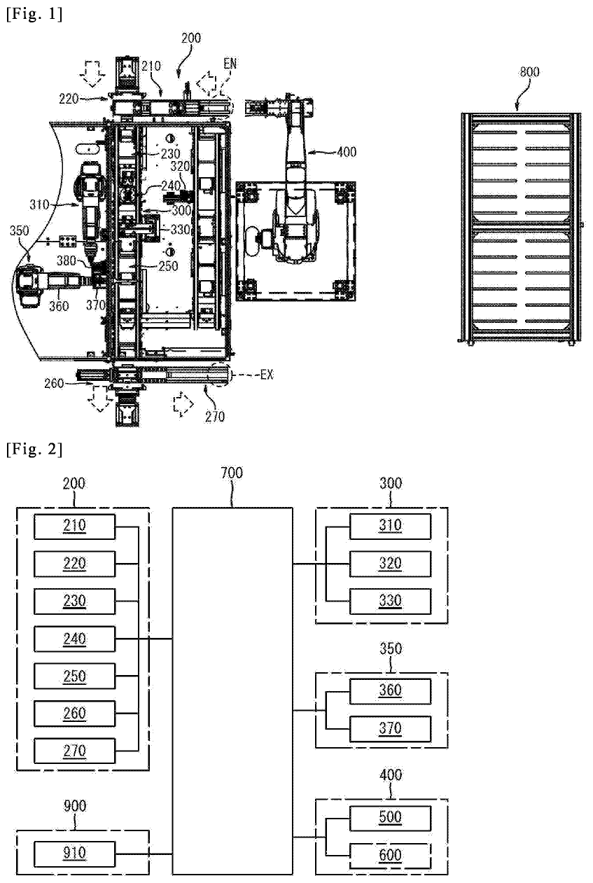

The conveying processing system 100 according to an embodiment of the present invention, as shown in FIG. 1, mainly comprises a conveying conveyor system 200, an unlocking system 300, a robot arm 400 with a second robot hand, a control device 700 (see FIG. 2), and a management device 900 (see FIG. 2). Here, the conveying conveyor system 200, the unlocking system 300, the robot arm 400 with the second robot hand, and the management device 900 are communicatively connected to the control device 700 as shown in FIG. 2. Incidentally, a robot arm with a first robot hand for taking out a bill is showed by a reference sign 350 in FIG. 2, and it will be described later.

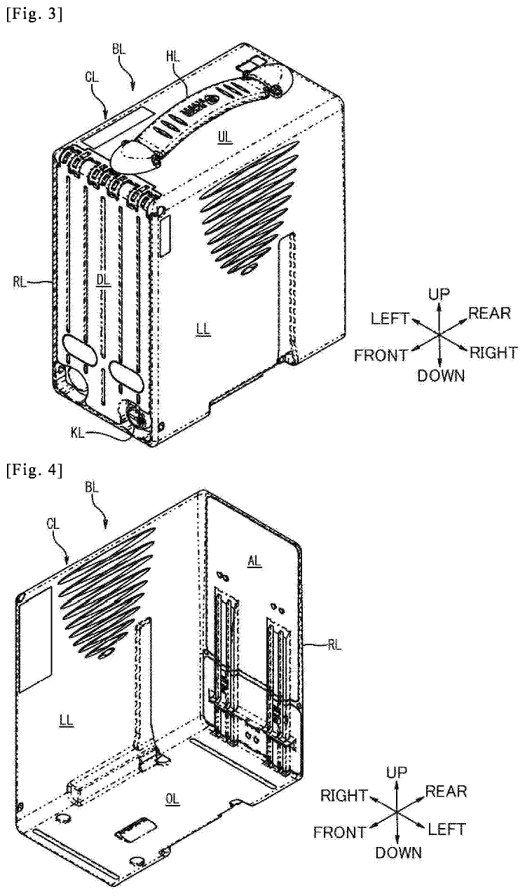

Incidentally, in this conveying processing system 100, the bill storage container BL, BS (see FIGS. 3 to 6) is conveyed in the conveying conveyor system 200 (see FIG. 1) from a movable shelf 800 (see FIGS. 1, 25 and 26) by the robot arm 400 with the second robot hand. Then, after the bill storage container BL, BS is unlocked by the unlocking system 300 and a bill is taken out from the bill storage container BL, BS, the empty bill storage container BL, BS is conveyed from the conveying conveyor system 200 to the movable shelf 800 by the robot arm 400 with the second robot hand. Hereinafter, after a structure and the like of the bill storage container BL, BS to be processed is described, components of the conveying processing system 100 will be described in detail.

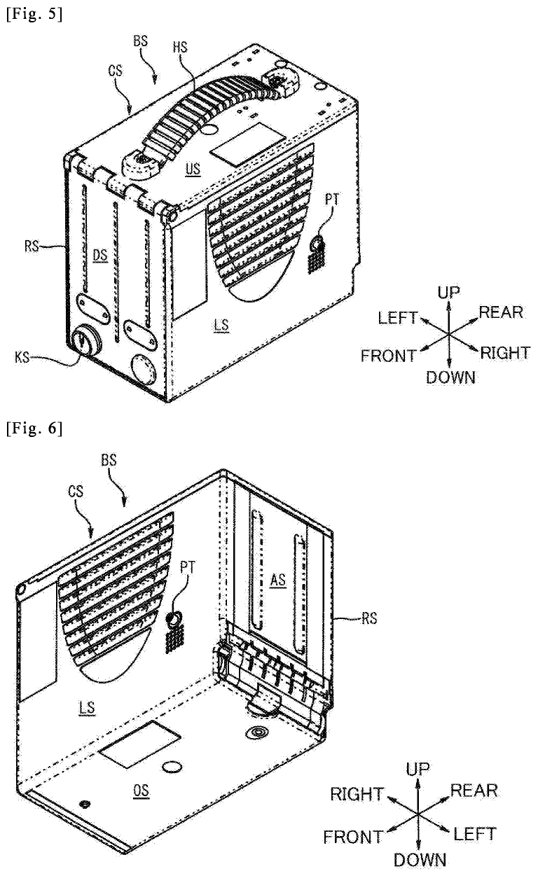

There are 2 types of bill storage containers that are subjected to a conveying processing and an unlocking processing of the conveying processing system 100 according to an embodiment of the present invention. One of them is the bill storage container showed by a reference sign BL in FIGS. 3 and 4, and the other is the bill storage container showed by a reference sign BS in FIGS. 5 and 6. Incidentally, the essential configuration of these bill storage containers BL, BS is substantially the same, and the only major differences are the dimension, the position of a lock, and the presence or absence of a protrusion portion PT (see FIGS. 5 and 6). Therefore, only the bill storage container BL will be described here, and the bill storage container BS will be understood by replacing “S” in the reference sign in FIGS. 5 and 6 with “L”. Incidentally, the bill storage container BL has a width dimension and a depth dimension substantially equal to those of the bill storage container BS, but has a height higher than that of the bill storage container BS. Further, the protrusion portion PT is attached to a side surface of the bill storage container BS, but a protrusion portion is not attached to the bill storage container BL.

As shown in FIGS. 3 and 4, the bill storage container BL mainly includes a housing CL, a front door DL, a handle HL, and a lock KL. The housing CL, as shown in FIGS. 3 and 4, is mainly formed from a top wall UL, a bottom wall OL, a right side wall RL, a left side wall LL and a back wall AL. The front door DL is attached to a front end of the top wall UL of the housing CL so as to be rotatable in the up-down direction. The handle HL, as shown in FIG. 3, is attached to the top wall UL so as to extend in the front-rear direction in the width direction center of the top wall UL. The lock KL is a normal rotary lock and is disposed at a lower right corner of the front door DL (in the bill storage container BS, a lock KS is disposed at a lower left corner of a front door DS). When a key is rotated with the key inserted into this lock KL, the lock is opened or closed. Further, in an embodiment of the present invention, an IC tag or the like for storing data about the bill storage container BL is embedded on a back side of the back wall AL of the bill storage container BL. This IC tag stores, for example, various types of data about the bill storage container BL. The various types of data about the bill storage container BL is, for example, a type of the bill storage container BL, identification data of a device (for example, such as a game machine of a slot machine or the like) which had been set, and the like.

### 1. Conveying Conveyor System

As shown in FIG. 1, the conveying conveyor system 200 has a substantially U-shape in a plan view, and mainly includes a first conveying-in conveyor 210, a conveying-in side posture changing device 220, a second conveying-in conveyor 230, a turntable (rotary table) 240, a first conveying-out conveyor 250, a conveying-out side posture changing device 260 and a second conveying-out conveyor 270. Hereinafter, these components will be described in detail.

### (1) First Conveying-In Conveyor

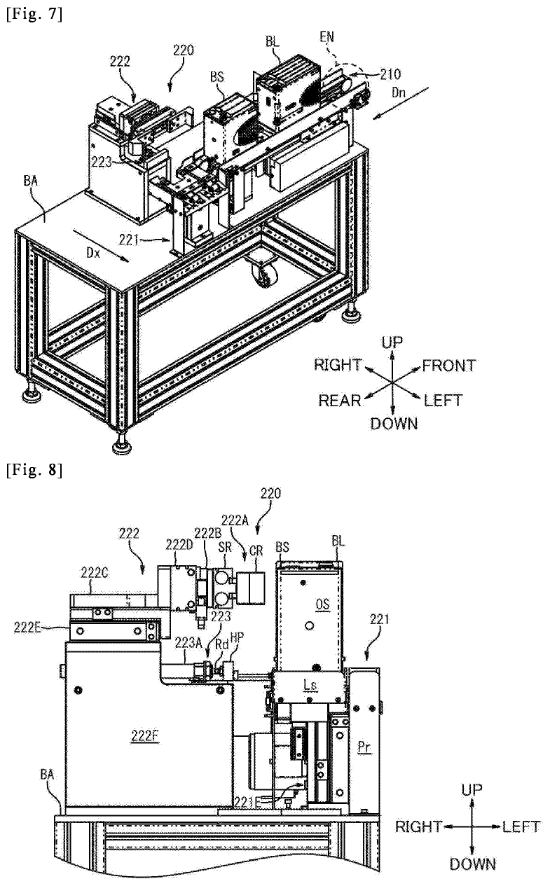

The first conveying-in conveyor 210 is an existing automatic conveying conveyor, and extends linearly toward an installation side of the conveying-in side posture changing device 220 from an installation side of the robot arm 400 with the second robot hand as shown in FIGS. 1 and 7. Incidentally, as shown in FIGS. 1 and 7, a portion of an installation side of the robot arm with the second robot hand of this first conveying-in conveyor 210 is a conveying-in position EN of the bill storage container BL, BS. As shown in FIG. 1, this conveying-in position EN is within the graspable range of the robot arm 400 with the second robot hand. Further, this first conveying-in conveyor 210, as shown in FIG. 2, is communicatively connected to the control device 700. Then, an output of a drive source of the first conveying-in conveyor 210 is controlled by the control device 700.

### (2) Conveying-In Side Posture Changing Device

As shown in FIGS. 7 and 8, the conveying-in side posture changing device 220 mainly includes an article support device 221, an article grasping rotation device 222, and an article pushing out device 223. Incidentally, the article grasping rotation device 222 is disposed above the article pushing out device 223 as shown in FIGS. 7 and 8, and the article grasping rotation device 222 and the article pushing out device 223 are disposed immediately beside the article support device 221 so as to face the article support device 221. Hereinafter, these components will be described in detail, and then the operation thereof will be described in detail.

### (2-1) Article Support Device

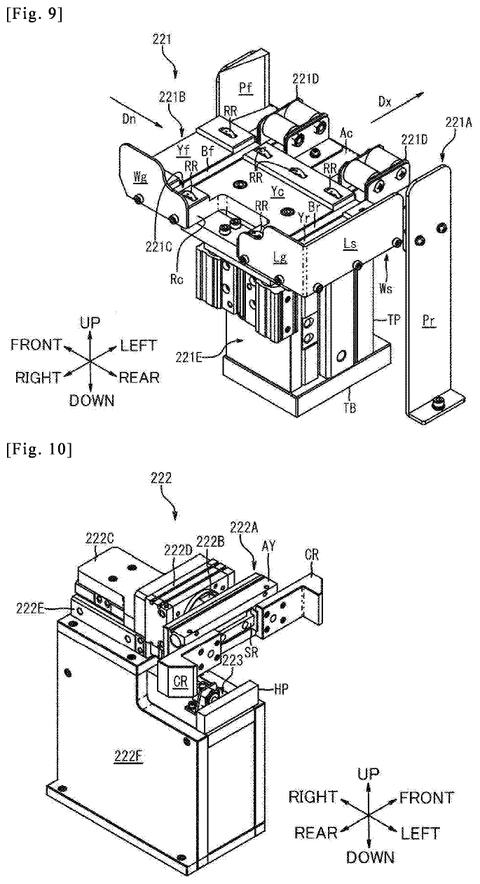

The article support device 221 has a function of receiving and supporting the bill storage container BL, BS conveyed from the first conveying-in conveyor 210. Further, when the bill storage container BL, BS is vertically rotated by 90° by the article grasping rotation device 222, the article support device 221 has a function of realizing a vertical rotation operation by the article grasping rotation device 222. As shown in FIG. 9, the article support device 221 mainly includes a pedestal portion TB, a pillar portion TP, a front pillar plate portion Pf, a rear pillar plate portion Pr, an intersecting passage portion Ac, a guide side wall Wg, an L-shaped wall Ws, an elevating table 221B, an elevating leg 221C, a conveying-out roller unit 221D, and an air cylinder unit 221E. Hereinafter, these configurations will be described in detail.

The pedestal portion TB is a thick plate member having a substantially rectangular shape as shown in FIG. 9, and serves to fix the pillar portion TP to a base table BA as shown in FIG. 7.

The pillar portion TP is a thick plate member having a substantially rectangular shape as shown in FIG. 9, and extends upward from the pedestal portion TB. This pillar portion TP supports the air cylinder unit 221E as shown in FIG. 9.

The front pillar plate portion Pf and the rear pillar plate portion Pr are a substantially rectangular plate member as shown in FIGS. 7 and 9, are disposed along the front-rear direction so as to sandwich the pillar portion TP, and are fixed to the base table BA. Further, as shown in FIG. 9, the front pillar plate portion Pf and the rear pillar plate portion Pr are fastened to the intersecting passage portion Ac, respectively.

The intersecting passage portion Ac is disposed on the left side (the side of the second conveying-in conveyor) of the elevating table 221B in a plan view (see FIG. 7), and is supported by the front pillar plate portion Pf and the rear pillar plate portion Pr as shown in FIG. 9.

The guide side wall Wg is a flat wall for guiding the bill storage container BL, BS that is conveyed through the first conveying-in conveyor 210 to the elevating table 221B, and is disposed on the right side of the front side of the elevating table 221B. The L-shaped wall Ws is a wall having an L-shape in a plan view, and is formed of a guide side wall portion Lg and an abutting wall portion Ls. The guide side wall portion Lg is a flat wall portion for guiding the bill storage container BL, BS that is conveyed through the first conveying-in conveyor 210 to the elevating table 221B, and is disposed on the right side of the rear side of the elevating table 221B. The abutting wall portion Ls is a so-called stopper, and is disposed on the rear side of the elevating table 221B. The abutting wall portion Ls serves to block the bill storage container BL, BS that is conveyed through the first conveying-in conveyor 210 so as not to go to the back further.

The elevating table 221B is formed from a front table portion Yf, a central table portion Yc, a rear table portion Yr, and a table connecting portion (not shown). Incidentally, the front table portion Yf, the central table portion Yc and the rear table portion Yr are connected at the left and right ends by the table connecting portion. Further, as shown in FIG. 9, a slit is formed between the front table portion Yf and the central table portion Yc and between the central table portion Yc and the rear table portion Yr in this elevating table 221B. Incidentally, as described later, a front leg Bf and a rear leg Br of the elevating leg 221C are inserted through these two slits so as to be freely elevated. The front table portion Yf is a substantially rectangular thick plate portion. Then, one roller RR is rotatably provided at each of the left and right portions of this front table portion Yf. Incidentally, these rollers RR are rotatable along the conveying-in direction Dn of the bill storage container BL, BS. The central table portion Yc is a thick plate portion having a substantially concave shape in a plan view, and a notch Rc is formed on the right side as shown in FIG. 9. Incidentally, this notch Rc is formed so that the claw portion CR does not collide with the elevating table 221B when a grasping portion 222A of the article grasping rotation device 222 becomes a vertical posture and its claw portion CR slides downward. Further, as shown in FIG. 9, one roller RR is rotatably provided at each of the front and rear portions of the notch Rc of this central table portion Yc, and three rollers RR are rotatably provided at the portion of the opposite side (left side) of the notch Rc. Incidentally, these rollers RR are rotatable along the conveying-in direction Dn of the bill storage container BL, BS. The rear table portion Yr is a substantially rectangular thick plate portion. Then, one roller RR is rotatably provided at each of the left and right portions of this rear table portion Yr. Incidentally, these rollers RR are rotatable along the conveying-in direction Dn of the bill storage container BL, BS. Then, this elevating table 221B is disposed so that the notch Rc faces the article grasping rotation device 222 as shown in FIG. 7. This elevating table 221B is attached to a first air cylinder of the air cylinder unit 221E, and can be elevated by the first air cylinder. Incidentally, the uppermost position of this elevating table 221B is a position shown in FIG. 9, and the lowermost position is a position where the bill storage container BL, BS does not collide with the elevating table 221B when the bill storage container BL, BS is rotated by the article grasping rotation device 222.

The elevating leg 221C not only serves to lift the bill storage container BS in order to allow the grasping portion 222A of the article grasping rotation device 222 to grasp the bill storage container BS at a central portion in the depth direction thereof, but also serves as a rail that smoothly sends out the bill storage container BL, BS to the conveying-out roller unit 221D after a posture of the bill storage container BL, BS is changed by the article grasping rotation device 222. The elevating leg 221C, as shown in FIG. 9, is mainly formed from a front leg Bf, a rear leg Br and a leg connecting portion (not shown). The front leg Bf is disposed in the slit of the front side of the elevating table 221B as shown in FIG. 9. The rear leg Bris disposed in the slit of the rear side of the elevating table 221B as shown in FIG. 9. The leg connecting portion is a beam portion extending in the front-rear direction, and connects the front leg Bf and the rear leg Br at its back side. Incidentally, this leg connecting portion is disposed so as not to overlap with the table connecting portion of the elevating table 221B. Then, this elevating leg 221C is attached to a second air cylinder of the air cylinder unit 221E, and can be elevated by the second air cylinder. Incidentally, the uppermost position of this elevating leg 221C is a height position at which the grasping portion 222A of the article grasping rotation device 222 can grasp the central portion in the depth direction of the bill storage container BS having a low height, and is a position slightly higher than the conveying-out roller unit 221D. The lowermost position of this elevating leg 221C is a position lower than the top surface of the elevating table 221B.

The conveying-out roller unit 221D is for easily sending the bill storage container BL, BS whose posture is changed by the article grasping rotation device 222 to the second conveying-in conveyor 230, and is disposed on both sides of the intersecting passage portion Ac as shown in FIG. 9.

The air cylinder unit 221E is attached to the pillar portion TP as shown in FIG. 9. This air cylinder unit 221E includes a first air cylinder and the second air cylinder. Then, as described above, the first air cylinder elevates the elevating table 221B, and the second air cylinder elevates the elevating leg 221C. Incidentally, the first air cylinder and the second air cylinder of this air cylinder unit 221E are operated by air flow and air pressure generated using a solenoid valve (not shown) and the speed regulating valve (not shown) which are controlled to open and close by the control device 700 respectively. This solenoid valve and this speed regulating valve are connected to a compressor.

### (2-2) Article Grasping Rotation Device

The article grasping rotation device 222 is a so-called rotary chuck device, and mainly includes a grasping portion 222A, a rotation shaft portion 222B, a slider 222C, a first air cylinder 222D, a second air cylinder unit 222E, and a pedestal 222F as shown in FIG. 10. Hereinafter, these configurations will be described in detail.

The grasping portion 222A, as shown in FIG. 10, mainly includes a pair of claw portions CR, a slide rail portion SR and a third air cylinder. The pair of claw portions CR is slidably attached to the left and right of the slide rail portion SR as shown in FIG. 10. Then, these claw portions CR are spread or narrowed along the slide rail portion SR by the third air cylinder. Incidentally, the third air cylinder is attached to the slide rail portion SR, and is operated by air flow and air pressure generated using a solenoid valve (not shown) and a speed regulating valve (not shown) which are controlled to open and close by the control device 700. This solenoid valve and this speed regulating valve are connected to a compressor. The rotation shaft portion 222B is attached to the rear side of the third air cylinder unit of the grasping portion 222A, and is rotated by 90° clockwise or 90° counterclockwise by the first air cylinder 222D. That is, when the rotation shaft portion 222B is rotated by the first air cylinder 222D, the grasping portion 222A also rotates with it.

The slider 222C is attached to the rear side of the first air cylinder 222D, and can slide the grasping portion 222A, the first air cylinder 222D and the rotation shaft portion 222B in the left-right direction (the direction toward the article support device 221) by the second air cylinder unit 222E. Incidentally, the foremost position of this slider 222C is a position at which the grasping portion 222A can grasp the bill storage container BL, BS, and the rearmost position is a position at which the bill storage container BL, BS sent to the article support device 221 does not collide with the grasping portion 222A.

The first air cylinder 222D is a rotary air cylinder, and is fixed to the slider 222C as shown in FIG. 10. As described above, this first air cylinder 222D rotates the grasping portion 222A by 90° clockwise or 90° counterclockwise. Incidentally, this first air cylinder 222D is operated by air flow and air pressure generated using a solenoid valve (not shown) and a speed regulating valve (not shown) which are controlled to open and close by the control device 700. This solenoid valve and this speed regulating valve are connected to a compressor.

The second air cylinder unit 222E is fixed on the pedestal 222F as shown in FIG. 10. As described above, this second air cylinder unit 222E slides the slider 222C along the left-right direction. Incidentally, this second air cylinder unit 222E is operated by air flow and air pressure generated using a solenoid valve (not shown) and a speed regulating valve (not shown) which are controlled to open and close by the control device 700. This solenoid valve and this speed regulating valve are connected to a compressor.

### (2-3) Article Pushing Out Device

The article pushing out device 223 mainly includes a piston rod Rd, an abutting plate HP and an air cylinder 223A, as shown in FIG. 8. Hereinafter, these configurations will be described in detail.

The piston rod Rd is retractable by the air cylinder 223A. Incidentally, the abutting plate HP is attached to the distal end of this piston rod Rd. This abutting plate HP positions behind the grasping portion 222A of the article grasping rotation device 222 in a standby state (see FIG. 8), and moves to a position ahead of the grasping portion 222A of the article grasping rotation device 222 when operating, that is, when pushing out. Incidentally, the moving distance of this abutting plate HP is a distance required to send the bill storage container BL, BS to the second conveying-in conveyor 230 via the conveying-out roller unit 221D.

The air cylinder 223A is disposed behind the abutting plate HP. This air cylinder 223A protrudes and retracts the piston rod Rd as described above. Incidentally, this air cylinder 223A is operated by air flow and air pressure generated using a solenoid valve (not shown) and a speed regulating valve (not shown) which are controlled to open and close by the control device 700. This solenoid valve and this speed regulating valve are connected to a compressor.

### (2-4) Description of Operation of the Conveying-In Side Posture Changing Device

Hereinafter, a control mode in which the conveying-in side posture changing device 220 changes the posture of the bill storage container BL, BS, that is, a control mode in which the conveying-in side posture changing device 220 rotates the bill storage container BL, BS vertically will be described in detail. Incidentally, in the conveying-in side posture changing device 220, the identification of the bill storage container BL, BS is determined based on an image data obtained by an imaging device (not shown) disposed above the article support device 221. Further, whether the top wall UL, US or the bottom wall OL, OS of the bill storage container BL, BS faces the front is also determined based on the image data obtained by the imaging device.

### (2-4-1) Control Mode of Vertical Rotation of the Bill Storage Container BL

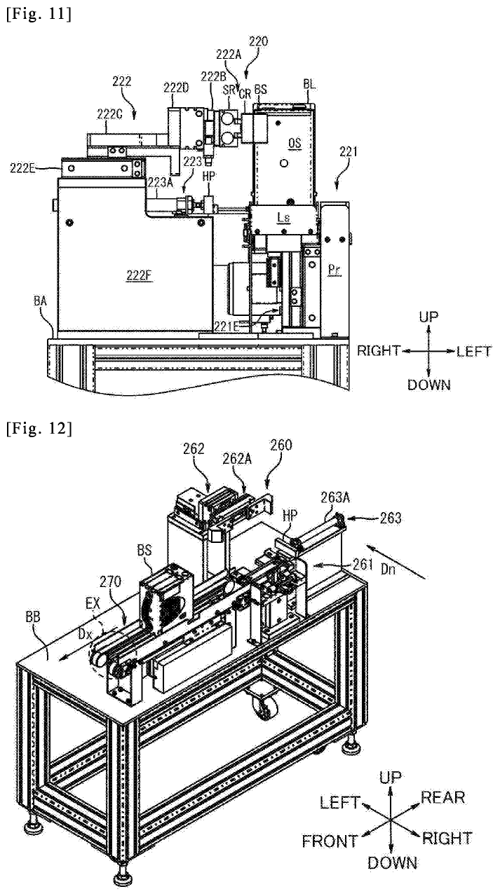

The conveying-in side posture changing device 220 is initially in the state shown in FIGS. 8 and 9. When the bill storage container BL is conveyed in this state and then becomes a state of being placed on the elevating table 221B of the article support device 221, the state is detected by an infrared sensor (not shown) disposed near the L-shaped wall Ws of the article support device 221, and then a detection signal is transmitted to the control device 700. Then, when the control device 700 receives the detection signal, the control device 700 lifts the elevating table 221B of the article support device 221 to the uppermost position. Next, after the control device 700 moves the slider 222C of the article grasping rotation device 222 forward (see FIG. 11), the control device 700 causes the grasping portion 222A of the article grasping rotation device 222 to grasp the bill storage container BL. Next, the control device 700 lowers the elevating table 221B of the article support device 221 to the lowermost position. Next, the control device 700 rotates the grasping portion 222A of the article grasping rotation device 222 by 90° clockwise or 90° counterclockwise by the first air cylinder 222D of the article grasping rotation device 222. Incidentally, when the bottom wall OL of the bill storage container BL faces forward (i.e., the conveying-in direction Dn), the first air cylinder 222D rotates the grasping portion 222A in the counterclockwise direction (the direction that the top wall UL faces upward), and when the top wall UL of the bill storage container BL faces forward, the first air cylinder 222D rotates the grasping portion 222A in the clockwise direction (the direction that the top wall UL faces upward). Subsequently, the control device 700 lifts the elevating table 221B of the article support device 221 to the uppermost position and lifts the elevating leg 221C to the uppermost position. At this time, the elevating leg 221C abuts against the bottom wall OL of the bill storage container BL to support the bill storage container BL. Subsequently, the control device 700 causes the grasping portion 222A to release the bill storage container BL, and then retreats the slider 222C of the article grasping rotation device 222. Thereafter, the control device 700 pushes out the bill storage container BL from the elevating table 221B by the air cylinder 223A of the article pushing out device 223, and moves the bill storage container BL to the second conveying-in conveyor 230 via the conveying-out roller unit 221D.

### (2-4-2) Control Mode of Vertical Rotation of the Bill Storage Container BS

The description until the control device 700 receives the detection signal from the infrared sensor is as described in (2-4-1), the description thereof will be omitted. When, the control device 700 receives the detection signal from the infrared sensor, the control device 700 lifts the elevating table 221B and the elevating leg 221C of the article support device 221 to their respective uppermost positions. Next, after the control device 700 moves the slider 222C of the article grasping rotation device 222 forward, the control device 700 causes the grasping portion 222A of the article grasping rotation device 222 to grasp the bill storage container BS. Next, the control device 700 lowers the elevating table 221B and the elevating leg 221C of the article support device 221 to the lowermost position. Next, the control device 700 rotates the grasping portion 222A of the article grasping rotation device 222 by 90° clockwise or 90° counterclockwise by the first air cylinder 222D of the article grasping rotation device 222. Incidentally, when the bottom wall OS of the bill storage container BS faces forward (i.e., the conveying-in direction Dn), the first air cylinder 222D rotates the grasping portion 222A in the counterclockwise direction (the direction that the top wall US faces upward), and when the top wall US of the bill storage container BS faces forward, the first air cylinder 222D rotates the grasping portion 222A in the clockwise direction (the direction that the top wall US faces upward). Subsequently, the control device 700 lifts the elevating table 221B of the article support device 221 to the uppermost position, and lifts the elevating leg 221C to the uppermost position. At this time, the elevating leg 221C abuts against the bottom wall OS of the bill storage container BS to support the bill storage container BS. Since the following operations are as described in (2-4-1), the description thereof will be omitted.

### (3) Second Conveying-In Conveyor

The second conveying-in conveyor 230 is an existing automatic conveying conveyor, and extends linearly toward an installation side of the turntable 240 from an installation side of the conveying-in side posture changing device 220 as shown in FIG. 1. Incidentally, as shown in FIG. 1, in a plan view, a conveying direction of this second conveying-in conveyor 230 is perpendicular to the conveying-in direction Dn of the first conveying-in conveyor 210. Incidentally, this second conveying-in conveyor 230, as shown in FIG. 2, is communicatively connected to the control device 700. Then, an output of a drive source of the second conveying-in conveyor 230 is controlled by the control device 700.

### (4) Turntable

The turntable 240 is an existing turntable, and rotates a placed article along a horizontal surface. Incidentally, as shown in FIG. 2, this turntable 240 is communicatively connected to the control device 700. Then, an output and a rotation angle of a drive source of the turntable 240 are controlled by the control device 700.

### (5) First Conveying-Out Conveyor

The first conveying-out conveyor 250 is an existing automatic conveying conveyor, and extends linearly toward an installation side of the conveying-out side posture changing device 260 from an installation side of the turntable 240 as shown in FIG. 1. Incidentally, as shown in FIG. 1, in a plan view, a conveying-out direction of this first conveying-out conveyor 250 is the same direction as the conveying-in direction of the second conveying-in conveyor 230, and is perpendicular to the conveying-in direction Dn of the first conveying-in conveyor 210. Incidentally, as shown in FIG. 2, this first conveying-out conveyor 250 is communicatively connected to the control device 700. Then, an output of a drive source of the first conveying-out conveyor 250 is controlled by the control device 700.

### (6) Conveying-Out Side Posture Changing Device

As shown in FIG. 12, the conveying-out side posture changing device 260 mainly includes an article support device 261, an article grasping rotation device 262, an article pushing out device 263, and an article pulling-in device 264. Incidentally, the article grasping rotation device 262 is disposed immediately beside the article support device 261 so as to face the article support device 261, and the article pushing out device 263 is disposed behind the article support device 261. Further, the article pulling-in device 264 is disposed on the article support device 261. Hereinafter, these components will be described in detail, and the operation thereof will be described in detail.

### (6-1) Article Support Device

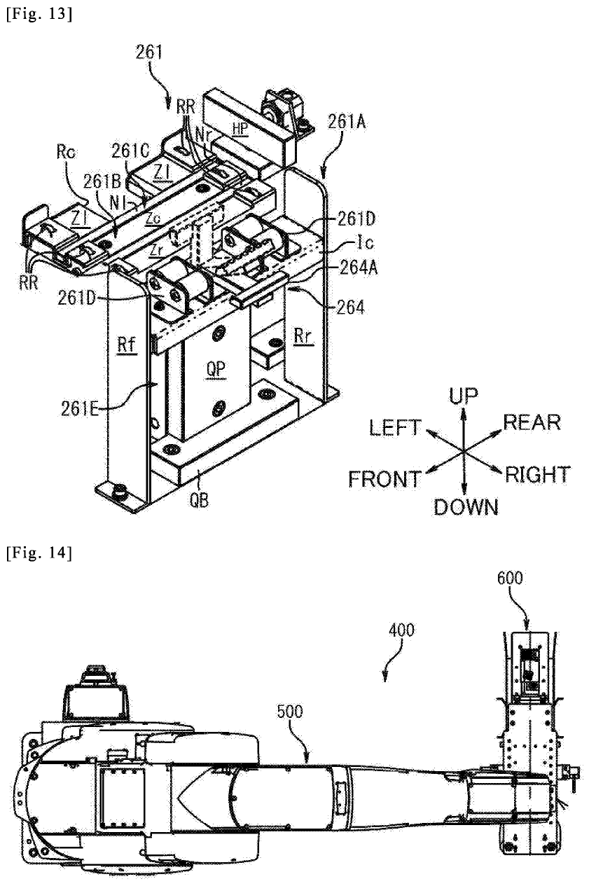

The article support device 261 has a function of receiving and supporting the bill storage container BL, BS conveyed from the first conveying-out conveyor 250, and has a function of realizing a vertical rotation operation by the article grasping rotation device 262 when the bill storage container BL, BS is vertically rotated by 90° by the article grasping rotation device 262. As shown in FIG. 13, the article support device 261 mainly includes a pedestal portion QB, a pillar portion QP, a front pillar plate portion Rf, a rear pillar plate portion Rr, an intersecting passage portion Ic, an elevating table 261B, an elevating leg 261C, a conveying-in roller unit 261D, and an air cylinder unit 261E. Hereinafter, these configurations will be described in detail.

The pedestal portion QB is a thick plate member having a substantially rectangular shape as shown in FIG. 13, and serves to fix the pillar portion QP to a base table BB as shown in FIG. 12.

The pillar portion QP is a thick plate member having a substantially rectangular as shown in FIG. 13, and extends upward from the pedestal portion QB. This pillar portion QP supports the air cylinder unit 261E as shown in FIG. 13.

The front pillar plate portion Rf and the rear pillar plate portion Rr are substantially rectangular plate members as shown in FIGS. 12 and 13, are disposed along the front-rear direction so as to sandwich the pillar portion QP, and are fixed to the base table BB. Incidentally, the upper portion of the front pillar plate portion Rf and the rear pillar plate portion Rr serve to guide the bill storage container BL, BS that is conveyed through the first conveying-out conveyor 250 to the elevating table 261B. Further, as shown in FIG. 13, this front pillar plate portion Rf and this rear pillar plate portion Rr are adjacent to the intersecting passage portion Ic.

The intersecting passage portion Ic is disposed on the right side (the first conveying-out conveyor side) of the elevating table 261B in a plan view (see FIG. 12), and is supported by the front pillar plate portion Rf and the rear pillar plate portion Rr as shown in FIG. 13. Incidentally, as shown in FIG. 13, a pair of conveying-in roller unit 261D is disposed in front and rear of the intersecting passage portion Ic, and the article pulling-in device 264 is disposed in the center thereof.

The elevating table 261B is formed from a left table portion Zl, a central table portion Zc, a right table portion Zr and a table connecting portion (not shown). Incidentally, the left table portion Zl, the central table portion Zc and the right table portion Zr are connected by the table connecting portion at the front and rear ends. Further, as shown in FIG. 13, a slit is formed between the left table portion Zl and the central table portion Zc and between the central table portion Zc and the right table portion Zr in this elevating table 261B. Incidentally, as described later, a left leg Nl and a right leg Nr of the elevating leg 261C are inserted through these two slits so as to be freely elevated. The left table portion Zl is a substantially rectangular thick plate portion having a notch Rc at the center. Incidentally, this notch Rc is formed so that the claw portion does not to collide with the elevating table 261B when the grasping portion of the article grasping rotation device 262 becomes a vertical posture and its claw portion slides downward. Then, one roller RR is rotatably provided at each of the front and rear portions of this left table portion Zl. Incidentally, these rollers RR are rotatable along the conveying-in direction Dn of the bill storage container BL, BS. The central table portion Zc is a thick plate portion having a substantially rectangular shape in a plan view. Further, as shown in FIG. 13, one roller RR is rotatably provided at each of the front and rear portions of this central table portion Zc. Incidentally, these rollers RR are rotatable along the conveying-in direction Dn of the bill storage container BL, BS. The right table portion Zr is a substantially rectangular thick plate portion. Then, one roller RR is rotatably provided at each of the front and rear portions of this right table portion Zr. Incidentally, these rollers RR are rotatable along the conveying-in direction Dn of the bill storage container BL, BS. Then, this elevating table 261B is disposed so that the notch Rc faces the article grasping rotation device 262 as shown in FIG. 13. This elevating table 261B is attached to a first air cylinder of the air cylinder unit 261E, and can be elevated by the first air cylinder. Incidentally, the uppermost position of this elevating table 261B is a position shown in FIG. 13, and the lowermost position is a position where the bill storage container BL, BS does not collide with the elevating table 261B when the bill storage container BL, BS is rotated by the article grasping rotation device 262.

The elevating leg 261C not only serves to lift the bill storage container BS in order to allow the grasping portion 262A of the article grasping rotation device 262 to grasp the bill storage container BS at a central portion in the depth direction thereof, but also serves as a rail that smoothly sends out the bill storage container BL, BS to the second conveying-out conveyor 270 after a posture of the bill storage container BL, BS is changed by the article grasping rotation device 222. As shown in FIG. 13, the elevating leg 261C is mainly formed from a left leg Nl, a right leg Nr and a leg connecting portion (not shown). The left leg Nl is disposed in the slit on the left side of the elevating table 261B as shown in FIG. 13. The right leg Nr is disposed in the slit of the right side of the elevating table 261B as shown in FIG. 13. The leg connecting portion is a beam portion extending in the left-right direction, and connects the left leg Nl and the right leg Nr at its back side. Incidentally, this leg connecting portion is disposed so as not to overlap with the table connecting portion of the elevating table 261B. Then, this elevating leg 261C is attached to a second air cylinder of the air cylinder unit 261E, and can be elevated by the second air cylinder. Incidentally, the uppermost position of this elevating leg 261C is a height position at which the grasping portion 222A of the article grasping rotation device 222 can grasp the central portion in the depth direction of the bill storage container BS having a low height, and is a position slightly higher than the conveying-in roller unit 261D. The lowermost position of this elevating leg 261C is a position lower than the top surface of the elevating table 261B.

The conveying-in roller unit 261D is for easily sending the bill storage container BL, BS sent from the first conveying-out conveyor 250 to the elevating table 261B, and is disposed in the front and rear (both side portions) of the intersecting passage portion Ic as shown in FIG. 13.

The air cylinder unit 261E is attached to the pillar portion QP as shown in FIG. 13. This air cylinder unit 261E includes a first air cylinder and a second air cylinder. Then, as described above, the first air cylinder elevates the elevating table 261B, and the second air cylinder elevates the elevating leg 261C. Incidentally, the first air cylinder and the second air cylinder of this air cylinder unit 261E are operated by air flow and air pressure generated using a solenoid valve (not shown) and a speed regulating valve (not shown) which are controlled to open and close by the control device 700 respectively. This solenoid valve and this speed regulating valve are connected to a compressor.

### (6-2) Article Grasping Rotation Device

Since the article grasping rotation device 262 is the same as the article grasping rotation device 222 of the conveying-in side posture changing device 220, a description thereof will be omitted here.

### (6-3) Article Pushing Out Device

The article pushing out device 263 mainly includes a piston 263A and an air cylinder unit (not shown), as shown in FIG. 12. Hereinafter, these configurations will be described in detail.

The piston 263A is retractable by the air cylinder unit. Incidentally, the abutting plate HP is attached to the distal end of this piston 263A. The abutting plate HP of this piston 263A positions behind the article support device 261 in a standby state (see FIG. 12), and moves to a position ahead of the article support device 261 when operating, that is, when pushing out. Incidentally, the moving distance of the abutting plate HP of this piston 263A is a distance required to send the bill storage container BL, BS to the second conveying-out conveyor 270.

The air cylinder unit is disposed behind the piston 263A. As described above, this air cylinder unit protrudes and retracts the piston 263A. Incidentally, this air cylinder unit is operated by air flow and air pressure generated using a solenoid valve (not shown) and the speed regulating valve (not shown) which are controlled to open and close by the control device 700. The solenoid valve and the speed regulating valve are connected to a compressor.

### (6-4) Article Pulling-In Device

The article pulling-in device 264 mainly includes a pulling-in member 264A, a rotary cylinder (not shown) and a bearing (not shown), as shown in FIG. 13. The bearing is provided on the front pillar plate portion Rf and the rear pillar plate portion Rr. The pulling-in member 264A is supported by the bearing rotatably as shown in FIG. 13. That is, this pulling-in member 264A is disposed between the pair of conveying-in roller unit 261D. Incidentally, this pulling-in member 264A is operated by the rotary cylinder.

### (6-5) Description of Operation of the Conveying-Out Side Posture Changing Device

Hereinafter, a control mode in which the conveying-out side posture changing device 260 changes the posture of the bill storage container BL, BS, that is, a control mode in which the conveying-out side posture changing device 260 rotates the bill storage container BL, BS vertically will be described in detail. Incidentally, in the conveying-out side posture changing device 260, the identification of the bill storage container BL, BS is determined based on an image data obtained by an imaging device (not shown) disposed above the article support device 261. Further, whether the top wall UL, US or the bottom wall OL, OS of the bill storage container BL, BS faces the front is also determined based on the image data obtained by the imaging device.

### (6-5-1) Control Mode of Vertical Rotation of the Bill Storage Container BL

The conveying-out side posture changing device 260 is initially in the state shown in FIGS. 12 and 13. When the bill storage container BL is conveyed in this state and then becomes a state of being placed on the elevating table 261B of the article support device 261, the state is detected by an infrared sensor (not shown) disposed near the rear pillar plate portion Rr of the article support device 261, and then a detection signal is transmitted to the control device 700. Then, when the control device 700 receives the detection signal, the control device 700 operates the article pulling-in device 264 to completely place the bill storage container BL on the elevating table 261B by the pulling-in member 264A. Next, the control device 700 lifts the elevating table 261B of the article support device 261 to the uppermost position. Next, after the control device 700 moves the slider of the article grasping rotation device 262 forward, the control device 700 causes the grasping portion 262A of the article grasping rotation device 262 to grasp the bill storage container BL. Next, the control device 700 lowers the elevating table 261B of the article support device 261 to the lowermost position. Next, the control device 700 rotates the grasping portion 262A of the article grasping rotation device 262 by 90° counterclockwise when viewed from the conveying-in direction Dn, by the air cylinder (rotary air cylinder) of the article grasping rotation device 262. Incidentally, when the bill storage container BL is rotated by 90° clockwise, the bill storage container BL becomes a posture in which the bottom wall OL faces the front (a conveying-out direction Dx), and when the bill storage container BL is rotated by 90° counterclockwise, the bill storage container BL becomes a posture in which the top wall UL faces the front (the conveying-out direction Dx). Incidentally, the rotation direction of the grasping portion 262A of the article grasping rotation device 262 is appropriately determined by the control device 700 (for example, the rotation direction is determined based on the placing pattern of the bill storage container BL on the movable shelf 800 and the like). Subsequently, the control device 700 lifts the elevating table 261B of the article support device 261 to the uppermost position and lifts the elevating leg 261C to the uppermost position. At this time, the elevating leg 261C abuts against the back wall AL of the bill storage container BL to support the bill storage container BL. Subsequently, the control device 700 causes the grasping portion 262A to release the bill storage container BL, and then retreats the slider of the article grasping rotation device 262. Thereafter, the control device 700 pushes out the bill storage container BL from the elevating table 261B by the piston 263A of the article pushing out device 263, and moves the bill storage container BL to the second conveying-out conveyor 270.

### (6-5-2) Control Mode of Vertical Rotation of the Bill Storage Container BS

The description until the control device 700 operates the article pulling-in device 264 and completely places the bill storage container BS on the elevating table 261B by the pulling-in member 264A is as described in (6-5-1), the description thereof will be omitted. When the control device 700 completely places the bill storage container BS on the elevating table 261B by the pulling-in member 264A, the control device 700 lifts the elevating leg 261C of the article support device 261 to the uppermost position. Next, after the control device 700 moves the slider of the article grasping rotation device 262 forward, the control device 700 causes the grasping portion 262A of the article grasping rotation device 262 to grasp the bill storage container BS. Next, the control device 700 lowers the elevating table 261B and the elevating leg 261C of the article support device 261 to the lowermost position. Subsequently, the control device 700 rotates the grasping portion 262A of the article grasping rotation device 262 by 90° counterclockwise when viewed from the conveying-in direction Dn, by a rotation portion of the article grasping rotation device 262. Subsequently, the control device 700 lifts the elevating table 261B of the article support device 261 to the uppermost position and lifts the elevating leg 261C to the uppermost position. At this time, the elevating leg 261C abuts against the back wall AS of the bill storage container BS to support the bill storage container BS. Since the following operations are as described in (6-5-1), and therefore, the description thereof will be omitted.

### (7) Second Conveying-Out Conveyor

The second conveying-out conveyor 270 is an existing automatic conveying conveyor, and extends linearly toward the installation side of the robot arm 400 with the second robot hand from the installation side of the conveying-out side posture changing device 260 as shown in FIGS. 1 and 12. Incidentally, as shown in FIGS. 1 and 12, a portion of an installation side of the robot arm with the second robot hand of this second conveying-out conveyor 270 is a conveying-out position EX of the bill storage container BL, BS. As shown in FIG. 1, this conveying-out position EX is within the graspable range of the robot arm 400 with the second robot hand. Further, as shown in FIG. 1, in a plan view, the conveying-out direction Dx of this second conveying-out conveyor 270 is perpendicular to the conveying direction of the second conveying-in conveyor 230 and the first conveying-out conveyor 250, and is parallel to the conveying-in direction Dn of the first conveying-in conveyor 210. Incidentally, this second conveying-out conveyor 270, as shown in FIG. 2, is communicatively connected to the control device 700. Then, an output of a drive source of the second conveying-out conveyor 270 is controlled by the control device 700.

### 2. Unlocking System

The unlocking system 300, as shown in FIG. 1, mainly includes a robot arm 310 with a key, an imaging device 320, an article detection device 330 and the robot arm 350 with the first robot hand. Hereinafter, these components will be described in detail.

(1) Robot Arm with Key

The robot arm 310 with the key has a key attached to the distal end of the robot arm. The type of the robot arm used is not particularly limited, and may be, for example, an existing six-axis robot arm or the like. Incidentally, the distal end portion of this robot arm is a rotatable structure, and the key is rotatable by the distal end portion of this robot arm. Incidentally, this robot arm 310 with the key not only serves to open the lock KL, KS of the bill storage container BL, BS and to pull up and open the front door DL, DS, but also serves to thereafter close the front door DL, DS of the bill storage container BL, BS and to lock the lock KL, KS.

### (2) Imaging Device

The imaging device 320 is fixed near the robot arm 310 with the key. This imaging device 320 captures the bill storage container BL, BS according to an instruction of the control device 700 to generate image data, and transmits the image data to the control device 700. Then, the control device 700 analyzes the image data and specifies the type of the bill storage container BL, BS.

### (3) Article Detection Device

The article detection device 330 is fixed near the robot arm 310 with the key. This article detection device 330 performs RFID communication with the IC tag of the bill storage container BL, BS in accordance with an instruction of the control device 700, reads various data of the IC tag, and transmits the various data to the control device 700. Then, the control device 700 analyzes the image data and specifies the type of the bill storage container BL, BS. Then, based on the various data and the image data from the imaging device 320, the control device 700 acquires the data of the type and dimensions of the bill storage container BL, BS, and derives the coordinate data of the lock KL, KS and the angle data of the lock KL, KS. Then, the control device 700 generates the control signal based on those data, transmits the control signal to the robot arm 310 with the key, and causes the robot arm 310 with the key to execute the unlocking processing of the bill storage container BL, BS. Further, when the control device 700 determines that the lock KL, KS do not exist in the bill storage container BL, BS in the image data, the control device 700 controls the turntable 240 to change the direction of the bill storage container BL, BS.

(4) Robot Arm with First Robot Hand

As shown in FIG. 1, the robot arm 350 with the first robot hand according to an embodiment of the present invention mainly includes a robot arm 360 and a first robot hand 370. Incidentally, this robot arm 350 with the first robot hand serves to pull out the bill from the bill storage container BL, BS with the front door DL, DS opened. Hereinafter, these components will be described in detail.

### (4-1) Robot Arm

The robot arm 360 is not particularly limited, but is, for example, an existing six-axis robot arm or the like.

### (4-2) First Robot Hand

The first robot hand 370 serves to pull out a bill from the bill storage container BL, BS with the front door DL, DS opened. For example, what is disclosed in specification of Japanese Patent No. 6773856, Japanese Patent No. 6756018, Japanese Patent No. 6587326 and Japanese Patent No. 6587325 can be used as the first robot hand 370. Incidentally, an imaging device 380 for recognizing the coordinate data of the lock KL, KS, the angle data of the lock KL, KS, and the presence or absence of the bill is attached to the first robot hand 370.

3. Robot Arm with Second Robot Hand

As shown in FIG. 14, the robot arm 400 with the second robot hand according to an embodiment of the present invention mainly includes a robot arm 500 and a second robot hand 600. Hereinafter, these components will be described in detail.

### (1) Robot Arm

The robot arm 500 is not particularly limited, but is, for example, an existing six-axis robot arm or the like (see FIG. 14).

### (2) Second Robot Hand

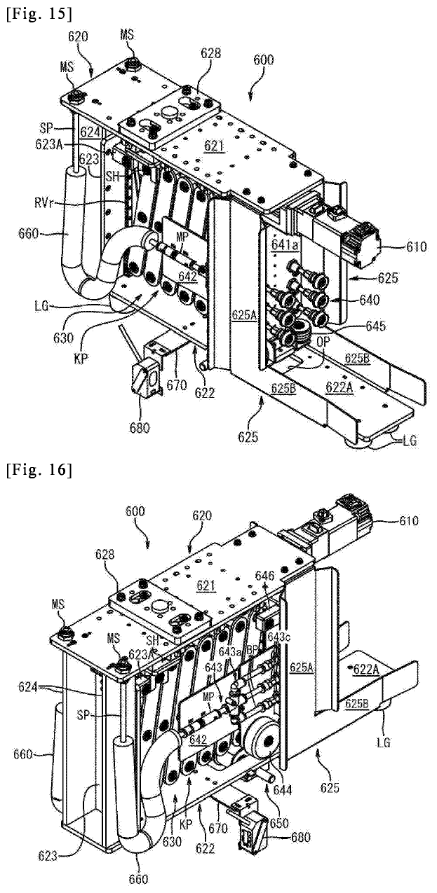

The second robot hand 600 mainly includes an electric motor 610, a frame 620, a link mechanism 630, a suction head unit 640, a detachable spiral spring unit 650, a flexible tube 660, a first sensor mounting plate 670, a first distance sensor 680, a second sensor mounting plate 675, and a second distance sensor 690, as shown in FIGS. 15 to 23. Hereinafter, these components will be described in detail.

### (2-1) Electric Motor

The electric motor 610 is a forward and reverse rotatable electric motor. Then, electric motor 610 is attached to the ball screw 615 so that its rotation axis coincides with the rotation axis of the ball screw 615. That is, this ball screw 615 can switch the sliding direction of the horizontal slider (described later) SH by switching the rotation direction of the electric motor 610. Incidentally, the load detection device (not shown) is connected to this electric motor 610 in this embodiment, the load of the electric motor 610 is detected by this load detection device.

### (2-2) Frame

Frame 620, as shown in FIGS. 15 to 23, mainly includes a top plate 621, a bottom plate 622, a back plate 623, a rear side plate 624 and a front side L-shaped plate 625. Hereinafter, these components will be described in detail.

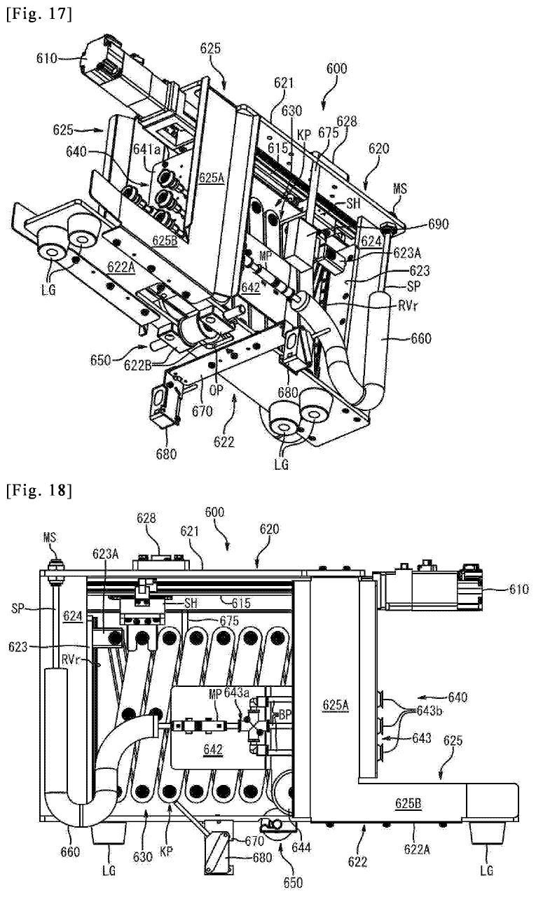

The top plate 621 is a substantially rectangular plate member as shown in FIG. 15 and the like, and covers the upper side of the second robot hand 600. As shown in FIGS. 15 to 18, on the lower side of the front portion of this top plate 621, the electric motor 610 is fixed so that the rotation axis extends toward the rear end. Further, as shown in FIGS. 15 and 16, a metal fitting 628 for mounting the robot arm are mounted slightly rearward than the central position in the longitudinal direction of the top plate 121. Further, as shown in FIG. 17, FIG. 18, and the like, the ball screw 615 is disposed on the back side (lower surface side) of the top plate 621.

The bottom plate 622 is a substantially rectangular plate member as shown in FIG. 17 and the like, and covers the lower side of the second robot hand 600. Incidentally, the front side portion 622A of the bottom plate 622 (see FIGS. 15 and 17) functions as a placing table of the article. Further, as shown in FIG. 17 and the like, a rectangular opening OP is formed substantially at the center of this bottom plate 622. This opening OP is sized so that the detachable spiral spring unit 650 can be mounted. Further, as shown in FIG. 17, support claws 622B are provided on both side edges of the opening OP of the bottom plate 622. This support claw 622B is for detachably supporting the shaft 653 of the detachable spiral spring unit 650. Further, left and right pair of legs LG are respectively attached to the front end portion and the rear end portion of the back side surface of the bottom plate 622, and the first sensor mounting plate 670 is attached to the back side surface of the slightly rear side of the opening OP of the bottom plate 622.

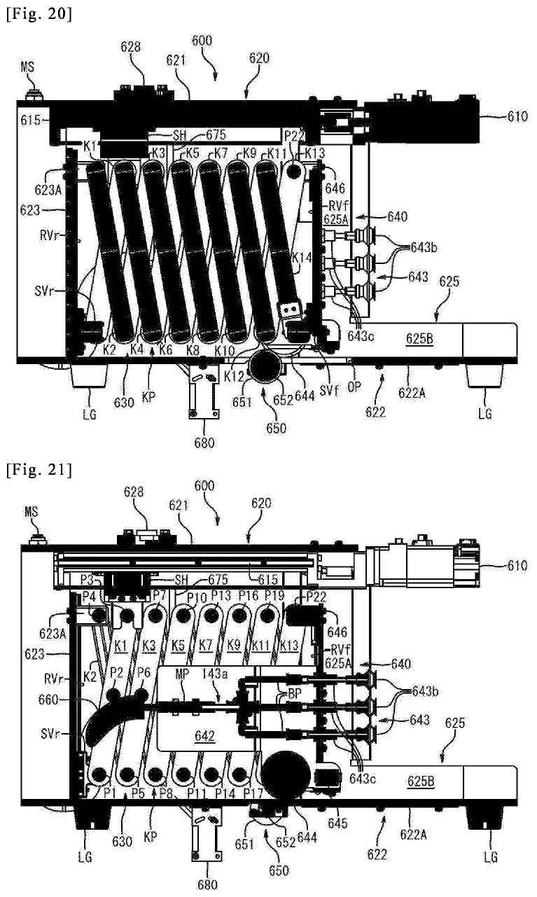

The back plate 623 is a substantially rectangular plate member as shown in FIGS. 15 and 18, and covers the back side of the second robot hand 600. Further, the rear vertical rail RVr and the rear support protrusion portion 623A are formed on the front surface of this back plate 623. As shown in FIGS. 20 and 21, a rear vertical slider SVr is attached to this rear vertical rail RVr so that the rear vertical slider SVr can slide in the up-down direction. The rear support protrusion portion 623A is a protrusion portion extending forward from the front surface of the back plate 623. As described later, a second node K2 is rotatably attached to this rear support protrusion portion 623A by a fourth link pin P4 at the base end portion.

The rear side plate 624 functions as a support pillar for supporting the top plate 621 and the bottom plate 622, and as shown in FIGS. 15 and 16, is provided on the rear side of the back plate in pairs on the left and right.

The front side L-shaped plate 625 is a plate member having a substantially L-shape in side view, and covers the side surface of the front end portion of the second robot hand 600, as shown in FIGS. 15 and 18 and the like. As shown in FIG. 15, FIG. 18, and the like, this front side L-shaped plate 625 is mainly formed of a vertical sidewall portion 625A and a horizontal sidewall portion 625B. Similarly to the rear side plate 624, the vertical sidewall portion 625A functions as a support pillar for supporting the top plate 621 and the bottom plate 622. On the other hand, as shown in FIG. 15 and the like, the horizontal sidewall portion 625B serves as a sidewall in the front side portion 622A of the bottom plate 622, and functions as a guide wall for guiding the suction head unit 640 forward. Specifically, the suction head unit 640 will be guided forward, while the guide roller 645 of the suction head unit 640 is in contact with the inner surface of the horizontal sidewall portion 625B and rolls. Further, as shown in FIG. 15 or the like, the front portion of the horizontal sidewall portion 625B is slightly open toward the width-wise outward. This is to make it easier to receive the article which is pulled in by the suction head unit 640.

### (2-3) Link Mechanism

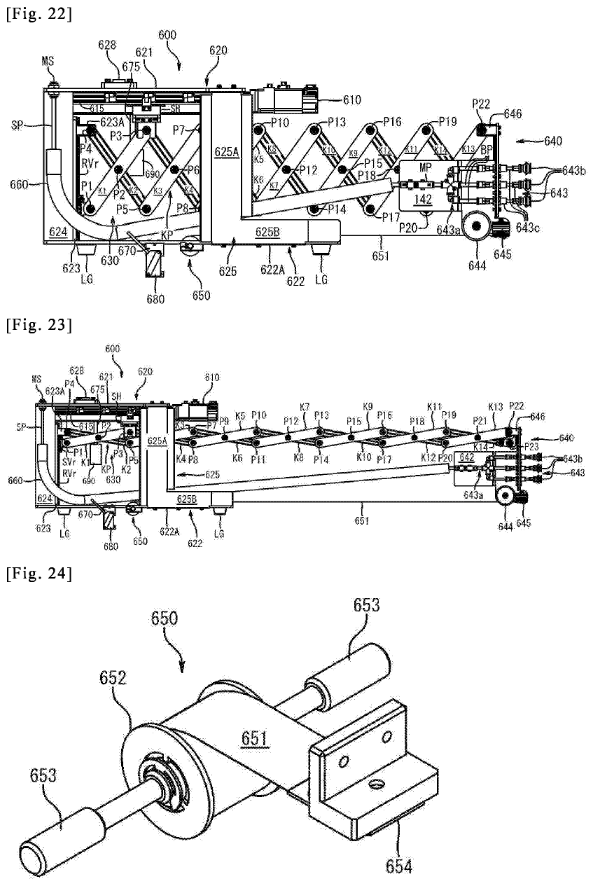

The link mechanism 630 is, for example, a telescopic lazy tong type link mechanism used for a magic hand or the like. In this embodiment, as shown in FIGS. 22 to 23, the link mechanism 130 includes 14 nodes (links) K1 to K14, 21 link pins P1 to P23, a rear vertical slider SVr, and a horizontal slider SH. Hereinafter, these components will be described in detail.

The nodes (links) K1 to K14 are plate bar-shaped members, and the link pins P1 to P23 are members that axially support the base end portion, the central portion, and the distal end portion of nodes K1 to K14 to form a link mechanism 130. Hereinafter, a structure composed of only the nodes (links) K1 to K14 and the link pins P1 to P23 may be referred to as a telescopic structure. Further, in this figure, the telescopic structure is denoted by the reference sign KP.

Here, the first node K1 is rotatably attached to the rear vertical slider SVr at the base end portion by the first link pin P1 (see FIGS. 20 to 23 and the like). Further, this first node K1 is rotatably attached to the central portion of the second node K2 at the central portion by the second link pin P2, and is rotatably attached to the base end portion of the fourth node K4 at the distal end portion by the third link pin P3 (see FIGS. 20 to 23, and the like). Incidentally, as shown in FIGS. 21 to 23, a horizontal slider SH is connected to the third link pin P3.

The second node K2 is rotatably attached to the rear support protrusion portion 123A at the base end portion by the fourth link pin P4 (see FIGS. 20 to 23 and the like). Further, the second node K2 is rotatably attached to the central portion of the first node K1 at the central portion by the second link pin P2, and is rotatably attached to the base end portion of the third node K3 at the distal end portion by the fifth link pin P5 (see FIGS. 20 to 23 and the like).

The third node K3 is rotatably attached to the distal end portion of the second node K2 at the base end portion by the fifth link pin P5, is rotatably attached to the central portion of the fourth node K4 at the central portion by the sixth link pin P6, and is rotatably attached to the base end portion of the sixth node K6 at the distal end portion by the seventh link pin P7 (see FIGS. 20 to 23 and the like).

The fourth node K4 is rotatably attached to the distal end portion of the first node K1 at the base end portion by the third link pin P3, is rotatably attached to the central portion of the third node K3 at the central portion by the sixth link pin P6, and is rotatably attached to the base end portion of the fifth node K5 at the distal end portion by the eighth link pin P8 (see FIGS. 20 to 23 and the like).

The fifth node K5 is rotatably attached to the distal end portion of the fourth node K4 at the base end portion by the eighth link pin P8, is rotatably attached to the central portion of the sixth node K6 at the central portion by the ninth link pin P9, and is rotatably attached to the base end portion of the eighth node K8 at the distal end portion by the tenth link pin P10 (see FIGS. 20-23 and the like).

The sixth node K6 is rotatably attached to the distal end portion of the third node K3 at the base end portion by the seventh link pin P7, is rotatably attached to the central portion of the fifth node K5 at the central portion by the ninth link pin P9, and is rotatably attached to the base end portion of the seventh node K7 at the distal end portion by the eleventh link pin P11 (see FIGS. 20 to 23 and the like).

The seventh node K7 is rotatably attached to the distal end portion of the sixth node K6 at the base end portion by the eleventh link pin P11, is rotatably attached to the central portion of the eighth node K8 at the central portion by the twelfth link pin P12, and is rotatably attached to the base end portion of the tenth node K10 at the distal end portion by the thirteenth link pin P13 (see FIGS. 20 to 23 and the like).

The eighth node K8 is rotatably attached to the distal end portion of the fifth node K5 at the base end portion by the tenth link pin P10, is rotatably attached to the central portion of the seventh node K7 at the central portion by the twelfth link pin P12, and is rotatably attached to the base end portion of the ninth node K9 at the distal end portion by the fourteenth link pin P14 (see FIGS. 20-23 and the like).

The ninth node K9 is rotatably attached to the distal end portion of the eighth node K8 at the base end portion by the fourteenth link pin P14, is rotatably attached to the central portion of the tenth node K10 at the central portion by the fifteenth link pin P15, and is rotatably attached to the base end portion of the twelfth node K12 at the distal end portion by the sixteenth link pin P16 (see FIGS. 20-23 and the like).

The tenth node K10 is rotatably attached to the distal end portion of the seventh node K7 at the base end by the thirteenth link pin P13, is rotatably attached to the central portion of the ninth node K9 at the central portion by the fifteenth link pin P15, and is rotatably attached to the base end portion of the eleventh node K11 at the distal end portion by the seventeenth link pin P17 (see FIGS. 20 to 23 and the like).

The eleventh node K11 is rotatably attached to the distal end portion of the tenth node K10 at the base end portion by the seventeenth link pin P17, is rotatably attached to the central portion of the twelfth node K12 at the central portion by the eighteenth link pin P18, and is rotatably attached to the base end portion of the fourteenth node K14 at the distal end portion by the nineteenth link pin P19 (see FIGS. 20 to 23 and the like).

The twelfth node K12 is rotatably attached to the distal end portion of the ninth node K9 at the base end portion by the sixteenth link pin P16, is rotatably attached to the central portion of the eleventh node K1l at the central portion by the eighteenth link pin P18, and is rotatably attached to the base end portion of the thirteenth node K13 at the distal end portion by the twentieth link pin P20 (see FIGS. 20 to 23 and the like).

The thirteenth node K13 is rotatably attached to the distal end portion of the twelfth node K12 at the base end portion by the twentieth link pin P20, and is rotatably attached to the central portion of the fourteenth node K14 at the central portion by the twenty-first link pin P21 (see FIG. 20, FIG. 21 and the like). Further, this thirteenth node K13 is rotatably attached to a front support protrusion portion 646 of the suction head unit 640 at the distal end portion by the twenty-second link pin P22 (see FIGS. 20 to 23 and the like).

The fourteenth node K14 is rotatably attached to the distal end portion of the eleventh node K11 at the base end portion by the nineteenth link pin P19, and is rotatably attached to the central portion of the thirteenth node K13 at the central portion by the twenty-first link pin P21 (see FIG. 21, FIG. 23 and the like). Further, this fourteenth node K14 is rotatably attached to a front vertical slider SVf of the suction head unit 640 at the distal end portion by the twenty-third link pin P23 (see FIGS. 20 to 23 and the like).

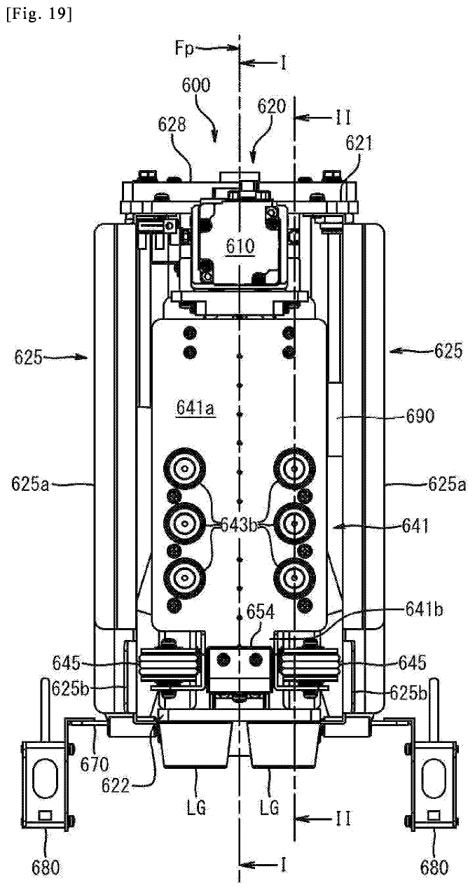

Incidentally, in the telescopic structure KP configured as described above, the 14 nodes K1 to K14 move along a virtual surface parallel to the virtual vertical surface Fp (see FIG. 19, this vertical surface Fp is a surface overlapping with the I-I cross section of FIG. 19).

As described above, the rear vertical slider SV can slide the rear vertical rail RVr of the back plate 623 in the up-down direction (see FIG. 20, FIG. 21 and the like). Incidentally, this rear vertical slider SVr rises with the forward movement of the horizontal slider SH, and falls with the backward movement of the horizontal slider SH.

The horizontal slider SH is engaged with the ball screw 615 as shown in FIG. 20, FIG. 21 and the like. The horizontal slider SH moves forward when the ball screw 615 is rotated forward, and moves backward when the ball screw 615 is reversed. Further, this horizontal slider SH is connected to the third link pin P3 as shown in FIGS. 21 to 23 and the like. That is, the telescopic structure KP is extended and contracted by the forward and backward movement of the horizontal slider SH.

### (2-4) Suction Head Unit

The suction head unit 640, as shown in FIGS. 15 and 19, mainly includes a front panel 641, a support plate 642, a suction pad unit 643, a wheel 644, a guide roller 645, a front vertical rail RVf, a front vertical slider SVf, and a front support protrusion portion 646. Hereinafter, these components will be described in detail.

As shown in FIG. 19, the front panel 641 is a plate member having an inverted convex shape in a front view, and mainly includes a main plate portion 641a and a lower protrusion portion 641b. As shown in FIG. 19, the main plate portion 641a is a plate portion having a substantially rectangular shape in a front view. As shown in FIG. 19, in the front view, three suction pads 643b are fixed to each of the left and right end portions of the lower portion of the main plate portion 641a. Incidentally, the distance of the left and right suction pads 643b is a distance sandwiching a handle without overlapping the handle when the handle of a box body with a handle faces the longitudinal direction. Further, as shown in FIG. 16, FIG. 20, and FIG. 21, the front support protrusion portion 646 extends rearward from the upper portion of the back surface of this main plate portion 641a. Further, as shown in FIGS. 22 and 23, the support plate 642 extends rearward from both end portions in the width direction of the back surface of this main plate portion 641a. Further, as shown in FIGS. 20 and 21, the front vertical rail RVf is disposed along the up-down direction on the back surface of this main plate portion 641a. As shown in FIG. 19, the lower protrusion portion 641b is a substantially square plate portion in a front view, and extends downward from the center of the lower side of the main plate portion 641a. A fastening block 654 of the detachable spiral spring unit 650 is screwed to this lower protrusion portion 641b. Incidentally, the screw used in this case is a detachable screw.

The support plate 642 is a plate member for supporting a pipe unit 143a of the suction pad unit 143 as shown in FIGS. 22 and 23, and extends rearward from both end portions in the width direction of the back surface of the main plate portion 641a of the front panel 641, as described above. Further, a pair of wheels 644 are axially supported on the lower portion of the front side of this support plate 642.

As shown in FIG. 15, FIG. 16 and the like, the suction pad unit 643 mainly includes a pipe unit 643a, a suction pad 643b, and an elastic connecting pipe 643c. The pipe unit 643a includes one main pipe MP and three branch pipes BP. Incidentally, the main pipe MP communicates with all three branch pipes BP. As shown in FIGS. 21 and 22, the main pipe MP is joined to the flexible tube 660 on the base end side, and the elastic connecting pipe 643c is joined to each branch pipe BP. The suction pad 643b is joined to the distal end side of each elastic connecting pipe 643c. Incidentally, the elastic connecting pipe 643c is provided with an elastic portion such as a coil spring. The elastic portion biases the distal end portion of the elastic connecting pipe 643c forward. That is, the suction pad 643b is biased forward through the distal end portion of the elastic connecting pipe 643c. Therefore, when the suction pad 643b brings into contact with the article and a load is applied to the suction pad 643b, the distal end portion of the elastic connecting pipe 643c and the suction pad 643b slightly retreat against the elastic force of the elastic portion, and when the load is not applied, the suction pad 643b returns to the original position by the elastic force of the elastic portion. The suction pad 643b is an extendable member formed of a flexible material.

The wheel 644, as described above, is axially supported on the lower portion of the front side of the support plate 642. That is, the rotation axis of this wheel 644 will follow a direction parallel to the width direction. This wheel 644 rolls over the top surface of the front side portion 622A of the bottom plate 622 of the frame 620, and rolls over the shelf plate of the shelf when it exceeds the front end portion of the front side portion 622A of the bottom plate 622 of the frame 620.

The guide roller 645 is a pillar shaped rotator having a rotation axis along an up-down direction, as described above, guides the suction head unit 640 forward while rolling in contact with the inner surface of the horizontal sidewall portion 625B of the front side L-shaped plate 625. Further, when a guide wall perpendicular to the shelf plate of the shelf is provided, the guide roller 645 guides the suction head unit 640 forward while rolling in contact with an inner surface of the guide wall.

The front vertical rail RVf, as shown in FIGS. 20 and 21 extends along the up-down direction on the back side surface of the front panel 641. A front vertical slider SVf is attached to this front vertical rail RVf so as to be freely slidable in the up-down direction (see FIGS. 20 and 21).

As described above, the front vertical slider SVf can slide the front vertical rail RVf in the up-down direction. Incidentally, this front vertical slider SVf rises with the forward movement of the horizontal slider SH and falls with the backward movement of the horizontal slider SH. Further, as described above, the fourteenth node K14 is rotatably attached to this front vertical slider SVf at the distal end portion by the twenty-third link pin P23.

The front support protrusion portion 646 is a protrusion portion extending rearward from the back side surface of the front panel 641. As described above, the thirteenth node K13 is rotatably attached to this front support protrusion portion 146 at the distal end portion by the twenty-second link pin P22.

### (2-5) Detachable Spiral Spring Unit

The detachable spiral spring unit 650 mainly includes a spiral spring 651, a holder 652, a shaft 653 and a fastening block 654, as shown in FIG. 24. The spiral spring 651 exists from the past and is biased so as to be wound around the holder 652. That is, when the hand of the person is released after the spiral spring 651 is extended by the hand of a person, the spiral spring 651 is wound around the holder 652 by its biasing force. The holder 652 is a cylindrical holding member (bobbin) for holding one end of the spiral spring 651. The shaft 653 extends along the axial direction of the holder 652 toward both directions of the holder 652 as shown in FIG. 24. Incidentally, as described above, this shaft 653 is detachably supported by the support claw 622B shown in FIG. 17. The fastening block 654 is a member for fixing the other end of the spiral spring 651 to the lower protrusion portion 641b of the front panel 641 of the suction head unit 640. The fastening block 654, as described above, is screwed to the lower protrusion portion 641b of the front panel 641 of the suction head unit 640.

### (2-6) Flexible Tube

The flexible tube 660, as shown in FIG. 15, FIG. 16 and the like, is joined to the outlet side of the base pipe SP, and is joined to the base end side of the main pipe MP of the suction pad unit 643, as described above. Incidentally, as shown in FIG. 15, FIG. 16 and the like, a piping port MS is joined to the inlet of the base pipe SP, and is provided at the rear end portion of the top plate 621 of the frame 620. Further, as shown in FIGS. 22 and 23, this flexible tube 660 has a sufficient length to correspond to the maximum extension state of the link mechanism 630.

### (2-7) First Sensor Mounting Plate

The first sensor mounting plate 670, as described above, is attached to the back side surface of the slightly rear side of the opening OP of the bottom plate 622 of the frame 620, and holds the first distance sensor 680 at both end sides and the middle part lower side thereof.

### (2-8) First Distance Sensor

The first distance sensor 680 is a sensor for detecting a distance to an object located on the front side, and is held on both end sides of the first sensor mounting plate 670 as described above. Then, the object mentioned here refers to anything such as the bill storage container BL, BS placed on the movable shelf 800, the bottom wall 810, the top wall 830, the square support pillar 840, the central support pillar 850, the shelf plate 820, the guide plate Wv, the normal hinged door and the sliding door of the movable shelf 800 and the like.

### (2-9) Second Sensor Mounting Plate

As shown in FIG. 17, the second sensor mounting plate 675 is attached to the right side of the top plate 621 of the frame 620, and holds the second distance sensor 690 at the lower end side thereof.

### (2-10) Second Distance Sensor

The second distance sensor 690 is a sensor for detecting a distance to an object located on the front side, and is held on the lower end side of the second sensor mounting plate 675 as described above. Then, the object mentioned here refers to anything such as the bill storage container BL, BS placed on the movable shelf 800, the bottom wall 810, the top wall 830, the square support pillar 840, the central support pillar 850, the shelf plate 820, the guide plate Wv, the normal hinged door and the sliding door of the movable shelf 800 and the like. Further, as shown in FIG. 2, the second robot hand 600 is communicatively connected to the management device 900, and the data of the distance to the object acquired by the second distance sensor 690 is transmitted to the management device 900. Further, when the second distance sensor 690 cannot detect the distance for some reason, the data of the distance to the object detected by the second distance sensor 690 is processed as infinity in the management device 900.

### 5. Control Device

The control device 700 is communicatively connected to the drive source of the conveying conveyor system 200, the unlocking system 300, the robot arm 350 with the first robot hand and the robot arm 400 with the second robot hand, the management device 900 and the like, respectively. The control device 700 transmits a control signal to the drive source and the like of the conveying conveyor system 200, the unlocking system 300, the robot arm 350 with the first robot hand and the robot arm 400 with the second robot hand. Further, the control device 700 receives various signals and data from the conveying conveyor system 200, the article detection device 330 and the imaging device 320 of the unlocking system 300, the management device 900 and the like. Further, this control device 700 transmits signals and data transmitted from the first distance sensor 680, the second distance sensor 690 and the like to the management device 900.

The various data that the control device 700 receives from the management device 900 are depth dimension data of the movable shelf 800, dimension data of the bill storage container BL, BS in the dimension data table 911, shelf dimension data of the shelf data table 912 (described later) and the like. As will be described in detail later, based on these data and the like, the control device 700 determines a shelf position for conveying out the bill storage container BL, BS placed on the movable shelf 800 and determines a shelf position for conveying in the bill storage container BL, BS to the movable shelf 800. Then, the control device 700 operates the robot arm 400 with the second robot hand and moves the second robot hand 600 to the determined shelf position.

### 6. Management Device

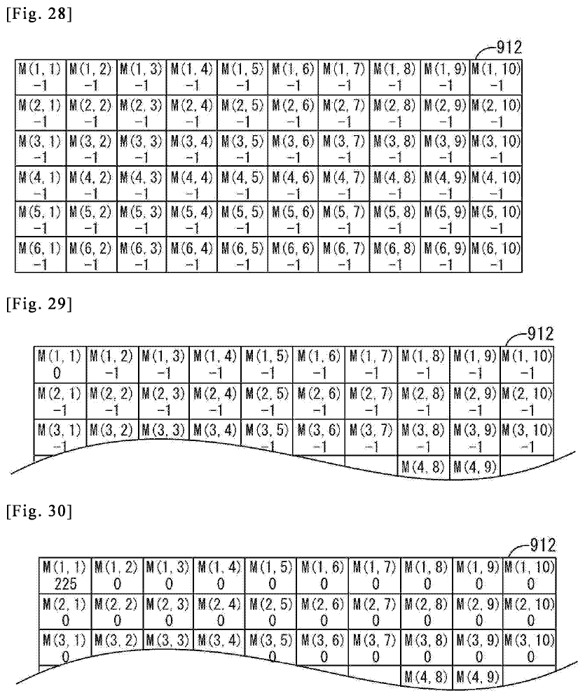

The management device 900, as shown in FIG. 2, is communicatively connected to the control device 700. The management device 900 receives various data (for example, distance data to an object acquired by the second distance sensor 690) and the like from the second distance sensor 690 of the second robot hand 600 via the control device 700 and transmits various signals, data and the like to the control device 700. Further, as shown in FIG. 2, the management device 900 comprises a storage unit 910. The storage unit 910 stores depth dimension data of the movable shelf 800 (that is, length data in the front-rear direction of the movable shelf 800) (not shown), a dimension data table 911 (see FIG. 27), a shelf data table 912 and the like (see FIGS. 28 to 30).

In the dimension data table 911, as shown in FIG. 27, the width dimension data, the depth dimension data and the height data of the bill storage container BL, BS are associated with the bill storage container BL, BS. The width dimension data of the bill storage container BL, BS shows the length data (see FIGS. 3 to 6) in the left-right direction of the bill storage container BL, BS, the depth-dimension data of the bill storage container BL, BS shows the length data (see FIGS. 3 to 6) in the front-rear direction of the bill storage container BL, BS and the height data of the bill storage container BL, BS shows the length data (see FIGS. 3 to 6) in the up-down direction of the bill storage container BL, BS. Incidentally, as described above, the bill storage container BL has the width dimension and the depth dimension substantially equal to those of the bill storage container BS, but has the height higher than the bill storage container BS. Therefore, in the dimension data table 911, A≈X, B≈Y and C>Z are established (see FIG. 27).

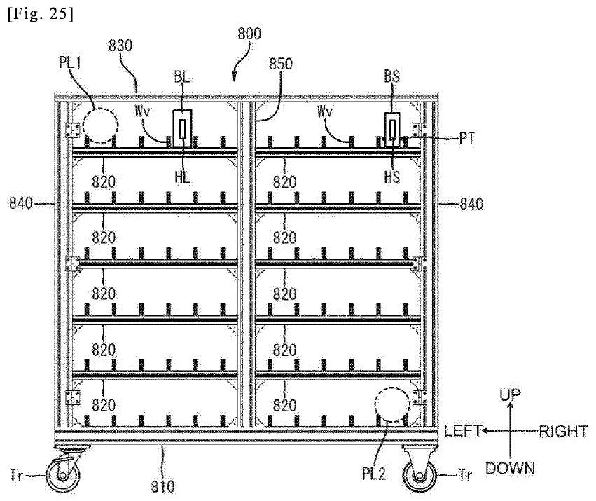

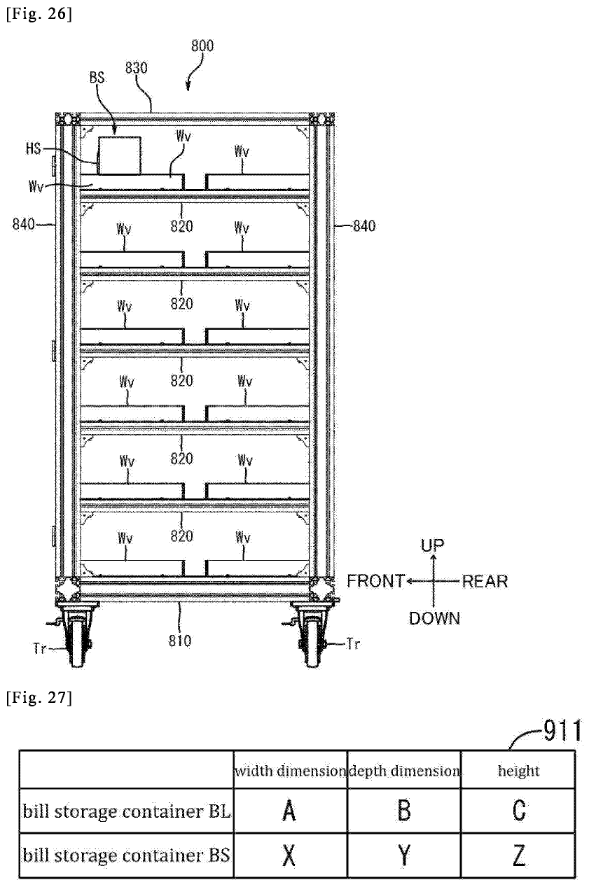

In the shelf data table 912, as shown in FIGS. 28 to 30, data showing each shelf position of the movable shelf 800 (hereinafter referred to as “shelf position data”) and state data for data showing each shelf position of the movable shelf 800 (hereinafter referred to as “state data”) are associated. As shown in FIGS. 28 to 30, each shelf position data is shown in the form of M (a, b), where “a” shows the stage number of the movable shelf 800 and “b” shows the column number of the movable shelf 800. More particularly, when the upper left of the movable shelf 800 is the first stage and the first column and the lower right of the movable shelf 800 is the sixth stage and the tenth column, M (1, 1) shows the position of the first stage and the first column of the movable shelf 800 (i.e., the shelf position PL1 shown in FIG. 25), and M (6, 10) shows the position of the sixth stage and the tenth column of the movable shelf 800 (i.e., the shelf position PL2 shown in FIG. 25). Then, as shown in FIGS. 28 to 30, the state data is shown by three types of numbers: “−1”, “O” and “positive number other than −1 and 0”. Here, “−1” shows an initial state before a process (see the control example of the conveying processing system 100 described later) of conveying out the bill storage container BL, BS placed on the movable shelf 800 is performed. “0” shows a state in which the bill storage container BL, BS is conveyed out from the movable shelf 800 and the bill storage container BL, BS is not placed at each shelf position of the movable shelf 800. Incidentally, when the distance data to the object acquired by the second distance sensor 690 becomes larger than the threshold value, the management device 900 inputs “O” to the state data. “Positive number other than −1 and 0” shows the sum of the height data of the bill storage container BL, BS at each shelf position when the process (see the control example of the conveying processing system 100 described later) of conveying in the bill storage container BL, BS to the movable shelf 800 is performed. For example, if the height data of the bill storage container BL is 225 mm, “positive number other than −1 and 0” is 225 if one bill storage container BL is placed on the shelf position, and is 450 if two bill storage containers BL are placed on the shelf position. Incidentally, here, the height data is used because the bill storage container BL, BS is laid down so that the handle HL, HS of the bill storage container BL, BS is on the front side when placed on the movable shelf 800 (in other words, the up-down direction shown in FIGS. 3 to 6 is laterally oriented along the front-rear direction shown in FIG. 26) (see FIG. 25).

### Control Example of the Conveying Processing System According to an Embodiment of the Present Invention

Here, control examples of the conveying processing system 100 when the conveying processing system 100 conveys out the bill storage container BL, BS placed on the movable shelf 800 shown in FIGS. 25 and 26 and conveys in the bill storage container BL, BS to the movable shelf 800 will be described.

Before the description of the control example, the movable shelf 800 and the regulation of the method of collecting the bill storage container BL, BS to this movable shelf 800 will be briefly described. As shown in FIGS. 25 and 26, the movable shelf 800 is mainly formed from a bottom wall 810, a top wall 830, a square support pillar 840, a central support pillar 850, a shelf plate 820, a guide plate Wv, and a wheel Tr. Incidentally, although not shown in FIG. 25, a normal hinged door or a slide door is attached to the front side and the rear side of the movable shelf 800. Further, although not shown in FIG. 26, side walls are provided on the left and right sides of the movable shelf 800. The bottom wall 810 and the top wall 830 are a rectangular plate member having the same dimensions. Incidentally, the bill storage container BL, BS can be placed on the bottom wall 810. The square support pillar 840 and central support pillar 850 is for supporting the top wall 830 and the shelf plate 820, and extends from the four corners and the central portion in the width direction of the upper surface of the bottom wall 810 to the four corners and the central portion in the width direction of the lower surface of the top wall 830, as shown in FIGS. 25 and 26. The shelf plate 820 is for placing the bill storage container BL, BS, and is a rectangular plate member having substantially the same dimensions as the bottom wall 810 and the top wall 830. As shown in FIGS. 25 and 26, the shelf plate 820 divides the spaces surrounded by the bottom wall 810, the top wall 830, the square support pillar 840 and the central support pillar 850 into six in the height direction, respectively. Further, as shown in FIGS. 25 and 26, a plurality of guide plates Wv is attached to the bottom wall 810 and the shelf plate 820. These guide plates Wv are substantially rectangular wall members for guiding the suction head unit 640 of the second robot hand 600 to the back and the front of the movable shelf 800 and for aligning the bill storage container BL, BS at intervals. These guide plates Wv extend upward along the depth direction from the upper surface of the bottom wall 810 and the shelf plate 820 as shown in FIGS. 25 and 26. That is, in this movable shelf 800, it is possible to place the bill storage container BL, BS on the bottom wall 810 and the shelf plate 820 from not only the front side (see FIG. 25) but also the rear side. Incidentally, as shown in FIG. 25, these guide plates Wv are arranged at intervals capable of accommodating the bill storage container BL, BS (in the case of the bill storage container BS, intervals that do not come into contract with the protrusion portion PT (described later)). That is, the dimension between the adjacent guide plate Wv and the guide plate Wv is designed to be larger than the width dimension of the bill storage container BL and the width dimension of the bill storage container BS including the protrusion portion PT. There are four wheels Tr, and each wheel Tr is attached to the four corners of the lower surface of the bottom wall 810. As a result, the movable shelf 800 is movable.

In an embodiment of the present invention, a method of collecting the bill storage container BL, BS to this moving shelf 800 is regulated. The regulation of the method of collecting is defined as “when the worker collects the bill storage container BL, BS to the movable shelf 800, the worker grasps a handle HL, HS of the bill storage container BL, BS and pushes the bill storage container BL, BS into the movable shelf 800 so that the bill storage container BL, BS is pushed into the movable shelf 800 from the bottom wall OL, OS (see FIGS. 25 and 26)”.

Hereinafter, control examples of the conveying processing system 100 from when the bill storage container BL, BS placed on the movable shelf 800 is conveyed out from the movable shelf 800 to the conveying processing system 100 until when the bill storage container BL, BS is conveyed in from the conveying processing system 100 to the movable shelf 800 will be described.

First, the user of the article conveying robot causes the management device 900 to store the dimension data table 911 and the shelf data table 912. At this time, as shown in FIG. 28, “−1” is shown in the state data in the shelf data table 912. Then, the user of this article conveying robot fixes the movable shelf 800 at a predetermined position and in a predetermined direction, and then operates the conveying processing system 100. When the conveying processing system 100 is operated, the robot arm 400 with the second robot hand begins to operate first. While the second robot hand 600 waiting at the initial position is lifted to a predetermined height position of the movable shelf 800 and is moved to the predetermined width direction position of the movable shelf 800 (e.g., the shelf position PL1 in FIG. 25) by the robot arm 500, the posture of the second robot hand 600 is controlled so that the front surface of the second robot hand 600 faces the front surface of the movable shelf 800 and the configuration surface (virtual vertical surface Fp) of the telescopic structure KP is parallel to the vertical direction. At this time, the pair of first distance sensors 680 provided in the second robot hand 600 face the adjacent guide plate Wv and the guide plate Wv. Next, the posture of the second robot hand 600 is controlled by the robot arm 500 so that the difference in the detection distance of the pair of first distance sensors 680 falls within the allowable range (ideally, the difference in the detection distance becomes 0) (at this time, the second robot hand 600 substantially faces the adjacent guide plate Wv and the guide plate Wv). Next, the second distance sensor 690 detects the distance to the object located on the front side. Incidentally, as described above, when the second distance sensor 690 cannot detect the distance for some reason, the distance to the object detected by the second distance sensor 690 is regarded as infinity. Here, if the bill storage container BL, BS is placed between the adjacent guide plate Wv and the guide plate Wv, the object is the bill storage container BL, BS. If the bill storage container BL, BS is not placed between the adjacent guide plate Wv and the guide plate Wv, the object is the normal hinged door or the slide door on the rear side of the movable shelf 800 or the wall (when the normal hinged door or the slide door is opened). When the second distance sensor 690 measures the distance to the object located on the front side, the second distance sensor 690 transmits the measured distance data (hereinafter sometimes referred to as “distance data”) to the management device 900. When the management device 900 receives the distance data, the management device 900 determines whether the distance data is larger than a threshold value. Here, the threshold value is, for example, a distance that exceeds the distance measured by the second distance sensor 690 when only one bill storage container BS (that is, a height smaller than the bill storage container BS) is placed on the innermost position of the shelf position of the movable shelf 800.

The Case that the Distance is Greater than the Threshold Value

The management device 900 inputs “O” to the state data for the corresponding shelf position data. For example, as shown in FIG. 29, when the second distance sensor 690 detects the distance greater than the threshold value at the shelf position of the first stage and the first column, the management device 900 inputs “O” to the shelf position data M (1, 1) of the first stage and the first column. Then, since it is determined that the bill storage container BL, BS is not placed on the shelf position where “0” is input, the second robot hand 600 is moved by the robot arm 500 to the predetermined position corresponding to another shelf position. In other words, the second robot hand 600 is moved by the robot arm 500 to the predetermined position corresponding to the shelf position where “−1” is shown relative to the corresponding shelf position data. Then, the second distance sensor 690 again performs the process of measuring the distance to the object located on the front side at the shelf position.

The Case that the Distance is Less than the Threshold Value

Since it is determined that the bill storage container BL, BS is placed on the shelf position, the process of conveying out the bill storage container BL, BS is performed. First, the electric motor 610 of the second robot hand 600 begins to operate, the link mechanism 630 extends, and the decompression pump begins to operate. Then, when the suction head unit 640 reaches to the movable shelf 800, the guide roller 645 contacts the adjacent guide plate Wv and the guide plate Wv to guide the suction head unit 640 to the back of the movable shelf 800. At this time, the wheel 644 rolls on the bottom wall 810 or the shelf plate 820 of the movable shelf 800. Then, when the load of the electric motor 610 detected by the load detecting device exceeds the threshold value, the electric motor 610 is temporarily stopped, and the bill storage container BL, BS is sucked by the suction pad 643b. Thereafter, the electric motor 610 is operated in the reverse, and the link mechanism 630 is contracted to finally return to the initial state (contracted state). At this time, the bill storage container BL, BS is placed on the front side portion 622A of the bottom plate 622 of the second robot hand 600. In this state, the robot arm 500 moves the second robot hand 600 to the conveying-in position EN (see FIG. 1) of the first conveying-in conveyor 210. When the second robot hand 600 reaches the conveying-in position EN by the robot arm 500, the electric motor 610 of the second robot hand 600 begins to operate, the link mechanism 630 is extended, and the bill storage container BL, BS is pushed out to the conveying-in position EN by the suction head unit 640. Then, the second robot hand 600 is again moved by the robot arm 500 to the predetermined position corresponding to the shelf position where the bill storage container BL, BS is conveyed out. Then, the second distance sensor 690 again performs the process of measuring the distance to the object located on the front side at the shelf position.

Incidentally, all such operations of the robot arm 500 and the second robot hand 600 are realized by the control device 700 which is communicatively connected to the robot arm 500 and the second robot hand 600.

The bill storage container BL, BS pushed out to the conveying-in position EN of the first conveying-in conveyor 210 is then conveyed to the conveying-in side posture changing device 220 by the first conveying-in conveyor 210, its posture is changed by the conveying-in side posture changing device 220 as described above, and the bill storage container BL, BS is conveyed to the second conveying-in conveyor 230.

The bill storage container BL, BS conveyed to the second conveying-in conveyor 230 is then conveyed to the turntable 240 by the second conveying-in conveyor 230. Then, when the lock KL, KS does not exist in the image data from the imaging device 320, the direction of the bill storage container BL, BS is changed by 180° by the turntable 240. Then, after the lock KL, KS of the bill storage container BL, BS is opened by the unlocking system 300 and the front door DL, DS of the bill storage container BL, BS is opened upward by the robot arm 310 with the key, the bill is taken out from the inside of the bill storage container BL, BS by the robot arm 350 with the first robot hand (during this time, the robot arm 310 with the key is the state where the key remains inserted into the lock KL, KS). Subsequently, the lock KL, KS is locked after the front door DL, DS of the bill storage container BL, BS is closed by the robot arm 310 with the key. Thereafter, the bill storage container BL, BS is conveyed to the first conveying-out conveyor 250 from the position corresponding to the arrangement position of the article detection device 330.

The bill storage container BL, BS conveyed to the first conveying-out conveyor 250 is then conveyed to the conveying-out side posture changing device 260 by the first conveying-out conveyor 250, its posture is changed by the conveying-out side posture changing device 260 as described above, and the bill storage container BL, BS is conveyed to the second conveying-out conveyor 270. Then, the bill storage container BL, BS is conveyed to the conveying-out position EX by the second conveying-out conveyor 270.

When the bill storage container BL, BS is conveyed to the conveying-out position EX, the second robot hand 600 is moved to the conveying-out position EX by the robot arm 500 (see FIG. 1). Then, the electric motor 610 of the second robot hand 600 begins to operate, the link mechanism 630 extends, and the decompression pump begins to operate. Then, when the suction head unit 640 reaches to the bill storage container BL, BS and the load of the electric motor 610 detected by the load detecting device exceeds the threshold value, the electric motor 610 is temporarily stopped, and the bill storage container BL, BS is sucked by the suction pad 643b. Thereafter, the electric motor 610 is operated in the reverse, and the link mechanism 630 is contracted to finally return to the initial state (contracted state). At this time, the bill storage container BL, BS is placed on the front side portion 622A of the bottom plate 622 of the second robot hand 600. Then, in this state, the second robot hand 600 is moved to the movable shelf 800 by the robot arm 500. Then, while the second robot hand 600 is moved by the robot arm 500 to the shelf position where “O” is input in the state data for the data showing the respective shelf positions of the movable shelf 800 in the shelf data table 912, the posture of the second robot hand 600 is controlled so that the front surface of the second robot hand 600 faces the front surface of the movable shelf 800 and the configuration surface (virtual vertical surface Fp) of the telescopic structure KP is parallel to the vertical direction. At this time, the pair of first distance sensors 680 provided in the second robot hand 600 face the adjacent guide plate Wv and the guide plate Wv. Next, the posture of the second robot hand 600 is controlled by the robot arm 500 so that the difference in the detection distance of the pair of first distance sensors 680 falls within the allowable range (ideally, the difference in the detection distance becomes 0) (at this time, the second robot hand 600 substantially faces the adjacent guide plate Wv and the guide plate Wv). Then, the process of conveying-in the bill storage container BL, BS to the shelf position of the movable shelf 800 is performed. First, the electric motor 610 of the second robot hand 600 begins to operate, and the link mechanism 630 extends. Then, when the suction head unit 640 reaches to the movable shelf 800, the guide roller 645 contacts the adjacent guide plate Wv and the guide plate Wv, and guides the suction head unit 640 and the bill storage container BL, BS to the back of the movable shelf 800. At this time, the wheel 644 rolls on the bottom wall 810 or the shelf plate 820 of the movable shelf 800. Then, when the load of the electric motor 610 detected by the load detecting device exceeds the threshold value, the electric motor 610 is temporarily stopped, the decompression pump is stopped, and the bill storage container BL, BS is released from the suction pad 643b. As a result, the bill storage container BL, BS can be placed on the shelf position of the movable shelf 800. Thereafter, the electric motor 610 is operated in the reverse, and the link mechanism 630 is contracted to finally return to the initial state (contracted state). Then, the management device 900 adds the “height data of the bill storage container BL, BS” to the state data for the corresponding shelf position data (see FIG. 30). Then, the control device 700 refers to the state data for the data showing the shelf position and determines whether or not the bill storage container BL, BS can still be conveyed in the shelf position. More particularly, when the value obtained by adding the “height data of the bill storage container BL, BS” to the “state data for the corresponding shelf position data” is still less than the “depth dimension data of the movable shelf 800”, it is determined that the bill storage container BL, BS can still be conveyed in the shelf position, and when this value becomes greater than the “depth dimension data of the movable shelf 800”, it is determined that the bill storage container BL, BS cannot be conveyed in the shelf position.

The Case that the Bill Storage Container BL, BS can Still be Conveyed in the Shelf Position

The second robot hand 600 is moved to the conveying-out position EX by the robot arm 500, and the bill storage container BL, BS conveyed to the conveying-out position EX is sucked by the suction pad 643b. Then, the second robot hand 600 is moved by the robot arm 500 to the predetermined position corresponding to the shelf position, and the posture of the second robot hand 600 is controlled as described above. Then, the second robot hand 600 places the bill storage container BL, BS on the shelf position, and finally returns to the initial state (contracted state). Then, the management device 900 adds the “height data of the bill storage container BL, BS” to the state data for the corresponding shelf position data. Then, the control device 700 refers to the state data for the corresponding shelf position data, and performs the process of determining whether or not the bill storage container BL, BS can still be conveyed in the shelf position.

The Case that the Bill Storage Container BL, BS Cannot be Conveyed in the Shelf Position

The second robot hand 600 is moved to the conveying-out position EX by the robot arm 500, and the bill storage container BL, BS conveyed to the conveying-out position EX is sucked by the suction pad 643b. Then, the second robot hand 600 is moved by the robot arm 500 to the predetermined position corresponding to the shelf position where “O” is input in the state data, and the posture of the second robot hand 600 is controlled as described above. Then, the second robot hand 600 places the bill storage container BL, BS on the shelf position, and finally returns to the initial state (contracted state). Then, the management device 900 adds the “height data of the bill storage container BL, BS” to the state data for each corresponding shelf position data. Then, the control device 700 refers to the state data for the corresponding shelf position data, and performs the process of determining whether or not the bill storage container BL, BS can still be conveyed in the shelf position.

Then, when the bill storage container BL, BS is no longer conveyed to the conveying-out position EX or the bill storage container BL, BS cannot be conveyed in each shelf position of the movable shelf 800 (that is, all of the state data for each shelf position data becomes greater than the “depth dimension data of the movable shelf 800” when the “height data of the bill storage container BL, BS” is added), the conveying processing system 100 ends the operation.

Hereinafter, the process when the bill storage container BL, BS conveyed to the conveying-out position EX is conveyed in the shelf position of the movable shelf 800 by the robot arm 400 with the second robot hand will be described using specific numbers. Here, it is assumed that the depth dimension data of the movable shelf 800 with the sixth stage and the tenth column is 784 mm, the height data of the bill storage container BL is 225 mm, the height data of the bill storage container BS is 186 mm, the state data “0” is associated with the shelf position data M (1,1) of the first stage and the first column of the movable shelf 800, and the state data “O” is associated with the shelf position data M (1,2) of the first stage and the second column of the movable shelf 800. For example, the robot arm 400 with the second robot hand convey in the bill storage container BL to the shelf position of the first stage and the first column. Next, the management device 900 adds “225” to the state data “0” for the shelf position data M (1, 1), and this state data becomes “225”. In this case, since the value obtained by adding the height data “225 or “186” of the bill storage container BL, BS to this state data “225” is still less than the depth dimension data “784” of the movable shelf 800, the control device 700 determines that the bill storage container BL, BS can still be conveyed in the shelf position of the first stage and the first column. Then, when two bill storage container BL are further conveyed in the shelf position of the first stage and the first column, the state data for the shelf position data M (1, 1) is added from “225” to “450” and from “450” to “675”. In this case, since the value obtained by adding the height data “225 or “186” of the bill storage container BL, BS to this state data “675” becomes greater than the depth dimension data “784” of the movable shelf 800, the control device 700 determines that the bill storage container BL, BS cannot be conveyed in the shelf position of the first stage and the first column. Then, the control device 700 controls the robot arm 400 with the second robot hand, and the robot arm 400 with the second robot hand conveys in the bill storage container BL, BS conveyed to the conveying-out position EX to the shelf position of the first stage and the second column instead of the shelf position of the first stage and the first column.

Incidentally, all such operations of the robot arm 500 and the second robot hand 600 are realized by the control device 700 which is communicatively connected to the robot arm 500 and the second robot hand 600.

### Features of the Conveying Processing System According to the Present Embodiment

(1) In the conveying processing system 100 according to the present embodiment, when the second robot hand 600 of the robot arm 400 with the second robot hand moves to the predetermined position corresponding to the shelf position of the movable shelf 800, the second distance sensor 690 of the second robot hand 600 of the robot arm 400 with the second robot hand measures the distance to the object located on the front side. Then, the management device 900 determines whether or not the distance is greater than the threshold value. Then, when the distance is greater than the threshold value, the management device 900 inputs “O” in the state data for the corresponding shelf position data and assumes that the bill storage container BL, BS is not placed on the shelf position, and the second robot hand 600 of the robot arm 400 with the second robot hand moves to the predetermined position corresponding to another shelf position. When the distance is less than the threshold value, the second robot hand 600 of the robot arm 400 with the second robot hand conveys out the bill storage container BL, BS placed on the shelf position. For this reason, in this conveying processing system 100, it is possible to efficiently proceed the work of conveying out the bill storage container BL, BS from the movable shelf 800.

(2) In the conveying processing system 100 according to the present embodiment, the second robot hand 600 of the robot arm 400 with the second robot hand moves to the predetermined position corresponding to the shelf position of the movable shelf 800 and conveys in the bill storage container BL, BS to the shelf position of the movable shelf 800. At this time, the management device 900 adds the “height data of the bill storage container BL, BS” to the state data for the corresponding shelf position data. Then, the control device 700 refers to the state data for the shelf position data and determines whether or not the bill storage container BL, BS can still be conveyed in the shelf position. Then, when the bill storage container BL, BS can still be conveyed in the shelf position, the second robot hand 600 of the robot arm 400 with the second robot hand conveys in the bill storage container BL, BS to the shelf position. When the bill storage container BL, BS cannot be conveyed in the shelf position, the second robot hand 600 of the robot arm 400 with the second robot hand moves to the predetermined position corresponding to another shelf position where the bill storage container BL, BS is not placed, and conveys in the bill storage container BL, BS to the shelf position. For this reason, in this conveying processing system 100, it is possible to efficiently proceed the work of conveying in the bill storage container BL, BS to the movable shelf 800.

(3) In the conveying processing system 100 according to the present embodiment, the second distance sensor 690 that detects the distance to the object located on the front side is attached to the second robot hand 600 of the robot arm 400 with the second robot hand. For this reason, in this conveying processing system 100, the second distance sensor 690 can also move as the second robot hand 600 moves. Therefore, in this conveying processing system 100, it is not necessary to install the distance measuring device at each shelf position of the movable shelf 800 or the like, and thus it is possible to reduce the construction cost of the conveying processing system 100.

### Modification

(A) In the conveying processing system 100 according to the above embodiment, the bill storage container BL, BS with the rotary lock is adopted as the conveying target and the unlock target. However, other types of the bill storage container with the lock such as the bill storage container with the electromagnetic lock may be adopted as the conveying target and the unlock target.

(B) In the conveying processing system 100 according to the above embodiment, the bill storage container BL, BS with the rotary lock is adopted as the conveying target and the unlock target. However, other articles may be adopted as the conveying target and the unlock target. Incidentally, in this case, it is necessary to replace the unlocking system 300, the robot arm 350 with the first robot hand and the like with one suitable for processing the article.

(C) In the conveying processing system 100 according to the above embodiment, the suction type second robot hand 600 is adopted as the robot hand of the robot arm 400 with the second robot hand. However, the type of robot hand that grasps the article with fingers may be adopted as such the robot hand.

(D) In the conveying processing system 100 according to the above embodiment, the robot arm 400 with the second robot hand conveys in the bill storage container BL, BS to the shelf position of the movable shelf 800 and conveys out the bill storage container BL, BS from the shelf position of the movable shelf 800. However, the conveying device other than the robot arm 400 with the second robot hand may convey in the bill storage container BL, BS to the shelf position of the movable shelf 800 and convey out the bill storage container BL, BS from the shelf position of the movable shelf 800. The conveying device may be, for example, the belt conveyor or the like that extends to the innermost position of each shelf position of the movable shelf 800. In this case, the belt conveyor conveys the bill storage container BL, BS conveyed out from each shelf position of the movable shelf 800 to the conveying-in position EN, and conveys in the bill storage container BL, BS conveyed to the conveying-out position EX to each shelf position of the movable shelf 800. In this case, it is preferable that the distance measuring device for detecting the distance to the object located on the front side is installed at each shelf position of the movable shelf 800.

(E) Although the movable shelf 800 according to the above embodiment is not provided with the side wall, the movable shelf 800 may be provided with the side wall.

(F) The movable shelf 800 according to the above embodiment has six stages and ten columns. However, the movable shelf may have at least one stage and one column. In this case, the shelf position data may be changed in accordance with the number of stages and columns of the movable shelf.

(G) In the conveying processing system 100 according to the above embodiment, when the bill storage container BL, BS is conveyed in the shelf position of the movable shelf 800, the management device 900 adds the “height data of the bill storage container BL, BS” to the state data for the corresponding shelf position data. Then, the control device 700 determines that the bill storage container BL, BS can still be conveyed in the shelf position when the value obtained by adding the “height data of the bill storage container BL, BS” to the “state data for the shelf position data” is still less than the “depth dimension data of the movable shelf 800”, and determines that the bill storage container BL, BS cannot be conveyed in the shelf position when this value becomes greater than the “depth dimension data of the movable shelf 800”. However, prior to the bill storage container BL, BS being conveyed in the shelf position of the movable shelf 800, the management device 900 may first input the “depth dimension data (e.g., 784 mm) of the movable shelf 800” to the state data for the corresponding shelf position data. Then, each time the bill storage container BL, BS is conveyed in the shelf position of the movable shelf 800, the management device 900 may subtract the “height data of the bill storage container BL, BS” from the state data for each corresponding shelf position data (for example, 784 mm→559 mm→334 mm). Then, the control device 700 may determine that the bill storage container BL, BS can still be conveyed in the shelf position when the state data for the shelf position data is still greater than the “height data of the bill storage container BL, BS”, and may determine that the bill storage container BL, BS cannot be conveyed in the shelf position when this state data is less than the “height data of the bill storage container BL, BS”.

(H) In the conveying processing system 100 according to the above embodiment, the control device 700 and the management device 900 are provided separately. However, the control device 700 may be incorporated in the management device 900, or the management device 900 may be incorporated in the control device 700 (that is, the control device 700 and the management device 900 may be integrated into one device).

Incidentally, each of the above modifications may be applied alone or in combination.

### REFERENCE SIGNS LIST

100 Conveying processing system (article conveying system)
400 Robot arm with robot hand (conveying device)
600 Second robot hand (grasping device)
690 Second distance sensor (distance measuring device)
700 Control device (control unit)
800 movable shelf (shelf)
900 Management device (management unit)
910 Storage unit
BL bill storage box (article)
BS bill storage box (article)

1. An article conveying system comprising:
a conveying device capable of conveying an article;
a distance measuring device for measuring a distance from a predetermined position to an object in a predetermined direction; and
a management unit for managing presence or absence of the article based on information about the distance to the object measured by the distance measuring device located at the predetermined position.

2. The article conveying system according to claim 1, wherein the conveying device is a grasping device capable of grasping the article, and the distance measuring device is attached to the conveying device.

3. The article conveying system according to claim 1, wherein the management unit includes a storage unit and causes the storage unit to store information showing that there is no article when the distance exceeds a threshold value.

4. The article conveying system according to claim 3, wherein the article conveying system is an article conveying-out system for conveying out the article placed on a shelf including at least one of at least one column and at least one stage,
further comprising:
a control unit for moving the conveying device to the predetermined position corresponding to a second shelf position different from a first shelf position when information showing that there is no article is associated with information showing the first shelf position of the shelf unit and is stored in the storage unit in the management unit.

5. The article conveying system according to claim 3, wherein the article conveying system is an article conveying-in system for conveying in the article to a shelf including at least one of at least one column and at least one stage, the storage unit stores information about dimensions of the article, and numerical value information based on the dimensions of the article is associated with information showing a first shelf position of the shelf and is stored in the storage unit in the management unit,
further comprising: a control unit for moving the conveying device to the predetermined position corresponding to a second shelf position different from the first shelf position when the numerical value information stored in the storage unit satisfies a specific condition.

6. The article conveying system according to claim 2, wherein the management unit includes a storage unit and causes the storage unit to store information showing that there is no article when the distance exceeds a threshold value.
